(19) United States
(12) Patent Application Publication
(10) Pub. No.: US 2025/0136134 A1
(43) Pub. Date: May 1, 2025

(54) MACHINE OPERATION ASSISTANCE USING LANGUAGE MODEL-AUGMENTED OPERATOR MONITORING

(71) Applicant: NVIDIA Corporation, Santa Clara, CA (US)

(72) Inventors: Rajath SHETTY, Sunnyvale, CA (US); Ratin KUMAR, Cupertino, CA (US); Niral Lalit PATHAK, Santa Clara, CA (US); Niranjan AVADHANAM, Saratoga, CA (US)

(21) Appl. No.: 18/499,942

(22) Filed: Nov. 1, 2023

(51) Int. Cl. B60W 50/14; G06V 20/59; G10L 13/027; G10L 15/22

(52) U.S. Cl. CPC B60W 50/14; G06V 20/597; G10L 13/027; G10L 15/22; B60W 2050/143; B60W 2050/146

(57) ABSTRACT

Various embodiments of the present disclosure relate to operator assistance based on operator monitoring. For instance, during long drives, a driver may become drowsy or may not otherwise be alert. As such, particular embodiments have the capability of starting a conversation with the driver based on driver interests and/or detecting that the driver is getting drowsy. In an illustrative example, a Driver Monitoring System (DMS) camera of a vehicle may employ a component that derives pixel-level information showing head nodding, hands dropping, or the like. Based on image pattern characteristics in the image data, particular embodiments generate a score representing an alertness level. A representation of the alertness level can be provided as input to a machine learning model so that the model may generate a suitable natural language or other response, such as starting a conversation with personalized trivia, sending a control signal to honk a horn, or the like.

### CROSS-REFERENCE TO RELATED APPLICATIONS

This application is related to U.S. Patent Application No. TBD, entitled “Machine Operation Assistance Using Language Model-Augmented Perception,” filed on Nov. 1, 2023.

### BACKGROUND

Vehicles may be equipped with technologies that make driving safer or more convenient. For example, car virtual assistants may understand and respond to simple voice commands. This allows drivers to control various functions of the car without taking their hands off the wheel or eyes off the road. Additionally, drivers may use car virtual assistants to control their car's entertainment systems. This includes playing music from various sources, such as streaming services, radio, or personal devices, as well as adjusting volume and switching between tracks. Other capabilities of vehicle technologies include providing navigation assistance, phone integration allowing drivers to make hands-free phone calls or texts, and smart home integration so that drivers may control home smart devices from their car.

One of the primary drawbacks of these and other conventional technologies is that driving often requires substantial concentration to perceive and respond to stimuli within an environment, which often requires a substantial cognitive load to safely operate the vehicle. Distractions, unsafe driving conditions, and/or dangerous obstacles may create safety risks and accidents. However, by limiting the information conventional techniques provide to operators, these technologies omit potentially useful information that may streamline the driving experience and alleviate the cognitive load on operators, potentially limiting or even interfering with the operator's ability to safely navigate the vehicle through an environment.

### SUMMARY

Embodiments of the present disclosure relate to operator (e.g., driver) assistance using one or more language models (e.g., a Large Language Model (LLM)). For instance, some embodiments relate to providing-context specific information to an operator as part of a natural language dialogue or other natural language output. In an illustrative example, particular embodiments generate a natural language utterance (e.g., “as a reminder, there are lots of deer in this area”) based on extracting natural language text in a nearby traffic sign (e.g., a sign that reads “deer Xing”). Additionally or alternatively, some embodiments relate to engaging the operator (e.g., via a relevant conversation) based on operator monitoring. For instance, during long drives, a driver may become drowsy or may not otherwise be alert. As such, particular embodiments have the capability of engaging (e.g., starting or continuing a conversation) with the driver based on driver interests and/or in response to detecting a likelihood that the driver is getting drowsy.

In contrast to conventional systems, such as those described above, various embodiments provide rich information to operators, such as a natural language response generated by a language model. Such natural language response(s) may streamline the driving or operating experience and alleviate the cognitive load on operators. This allows the operator to safely navigate an ego-machine through an environment. In this way, there may be a reduction in distractions, unsafe driving conditions, and/or dangerous obstacles such that there are not as many safety risks and accidents.

In various example embodiments, such natural language response(s) may include (for example and without limitation), a natural language text summary of event data (e.g., weather data, traffic data, radio broadcast data) according to a geolocation of an ego-machine, a generated natural language sentence indicating whether a parking spot is available, a generated natural language sentence indicating whether an operator saw or missed a traffic sign, a natural language text summary of information about a destination and/or travel route, a natural langue response based on an operator's alertness level, a natural language response based on the operator's interests, and/or a natural language response to an operator's utterance.

In order to produce natural language responses, the language model may ingest or receive various inputs (or portions of an input). For instance, the inputs may be or include various prompts that have been subject to prompt engineering, prompt-tuning, and/or fine-tuning to elicit suitable natural language responses using a Large Language Model (LLM). For example, where a natural language response concerns an operator's alertness level, the prompt that is provided to the language model may include personalized information (e.g., an indication that the driver likes sports team X), a representation of a detected (e.g., computed, inferred, etc.) alertness level of the operator (e.g., “the operator is extremely sleepy”), a natural language instruction, such as “start a conversation with the driver that aligns with the driver's interests,” a one-shot or few shot prompt example of representative inputs and/or outputs (e.g., example conversations initiated at the KSS level), and/or “send a control signal to honk the horn.” In response to the language model ingesting such prompt, the language model may output a natural language response, such as “I've just honked the horn because you are falling asleep. Can you name some players that have played for team X that have made it to the Hall of Fame?”

### BRIEF DESCRIPTION OF THE DRAWINGS

The present systems and methods for subcutaneous authentication are described in detail below with reference to the attached drawing figures, wherein:

FIG. 1 is a data flow diagram illustrating an example natural language extraction pipeline, in accordance with some embodiments of the present disclosure;

FIG. 2 is a data flow diagram illustrating an example alertness level detector pipeline; in accordance with some embodiments of the present disclosure;

FIG. 3 is a block diagram of a Large Language Model that uses particular inputs to generate particular natural language responses, according to some embodiments;

FIG. 4A illustrates image data of a parking sign and a parking spot 408, according to some embodiments;

FIG. 4B illustrates a natural language response to the natural language characters being extracted from the traffic sign of FIG. 4A and/or the parking spot of FIG. 4A being detected, according to some embodiments;

FIG. 5A illustrates an ego-machine operator in a drowsy state and a responsive natural language response, according to some embodiments;

FIG. 5B illustrates the operator of FIG. 5A's response to the audio response of FIG. 5A and a model's response 5 to the operator's response, according to some embodiments;

FIG. 6 is a flow diagram of an example process for generating a natural language response based on extracting natural language character(s) represented in image data, according to some embodiments;

FIG. 7 is a flow diagram of an example process for extracting natural language characters from one or more objects, according to some embodiments;

FIG. 8 is a flow diagram of an example process for generating a natural language response based on a computed alertness level of an operator of an ego-machine, according to some embodiments;

FIG. 9 is a flow diagram of an example process for generating natural language characters based on providing a LLM different sets of image data, according to some embodiments;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

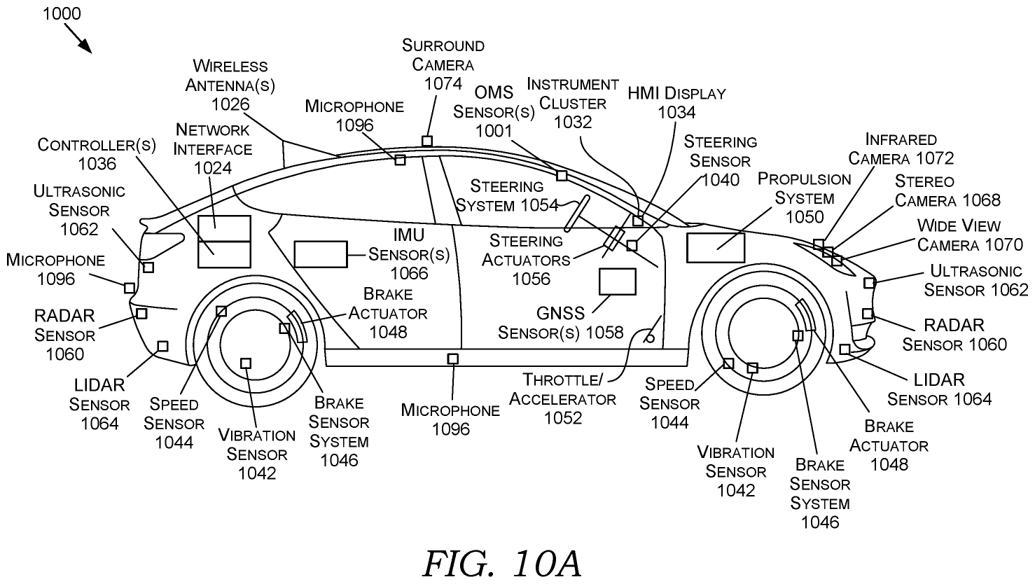

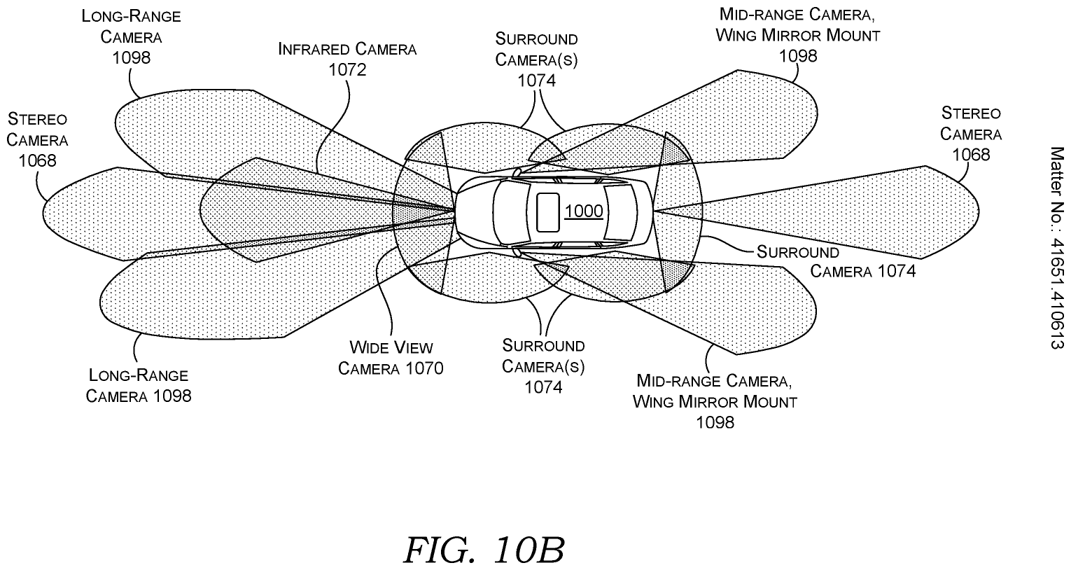

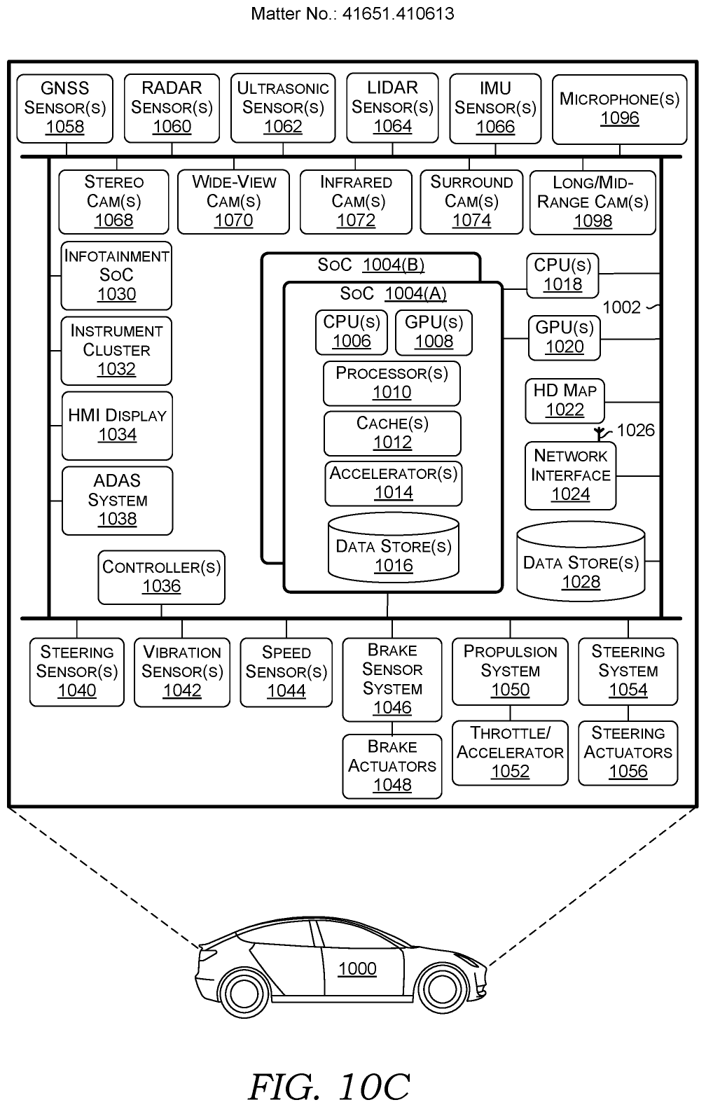

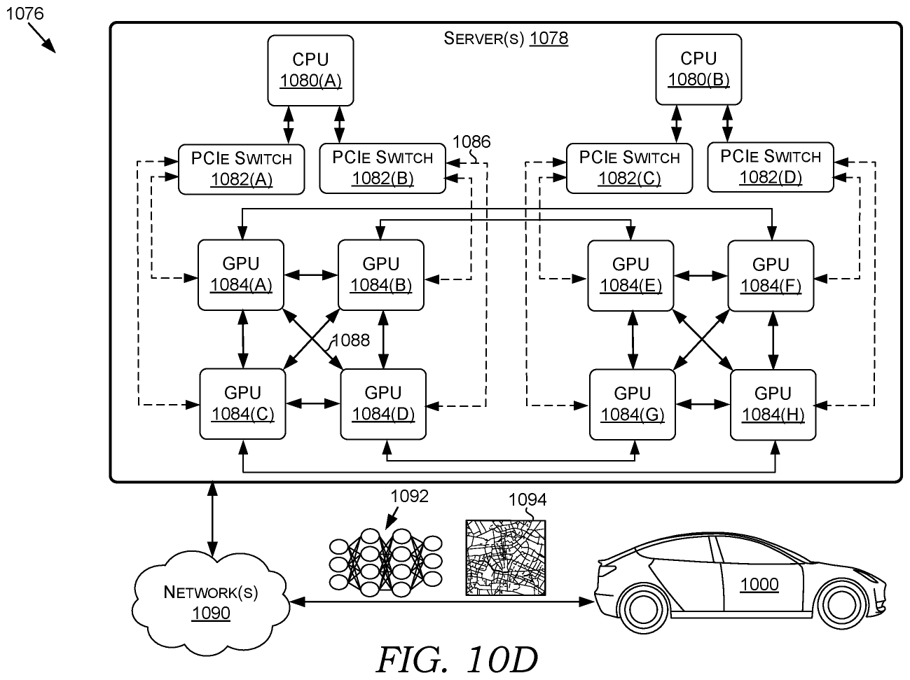

Embodiments of the present disclosure relate to operator (e.g., driver) assistance using one or more language models (e.g., a Large Language Model (LLM)). Although the present disclosure may be described with respect to an example autonomous or semi-autonomous vehicle or machine 1000 (alternatively referred to herein as “vehicle 1000” or “ego-machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to models that generate natural language responses based on extracting natural language information from object(s) and/or detecting the alertness level of an operator, this is not intended to be limiting, and the systems and methods described herein may be used in augmented reality, virtual reality, mixed reality, robotics, security and surveillance, autonomous or semi-autonomous machine applications, and/or any other technology spaces where authentication may be used.

Various embodiments of this disclosure are related to providing context-specific information to a driver or other operator as a natural language response (e.g., one or more characters, words, etc.). For example, systems and methods are disclosed that extract natural language characters (e.g., an English phrase) from image data representing objects (e.g., a traffic sign, a billboard, a convenient store) and generate responsive natural language outputs (e.g., “you may not park in this spot since it is not 6 p.m. yet”). In an illustrative example, one or more sensors (e.g., one or more cameras) mounted on an ego-machine (e.g., a vehicle) may capture image data that includes a representation of a traffic sign in an environment. The sensors may detect, via object detection or segmentation, one or regions of the image data within which the traffic sign was detected. In some instances, a speed sensor (e.g., an inductive sensor) in the vehicle may detect that the vehicle is below and/or exceeds a threshold speed. Responsive to the vehicle falling below and/or exceeding the speed threshold and/or the detection/segmentation of the traffic sign, particular embodiments extract natural language characters within the one or more regions of image data representing the detected traffic sign. For example, Optical Character Recognition (OCR) may be used to encode elements of the image data into machine-readable natural language text (e.g., via pattern matching or feature extraction methods). Such natural language text may be, for example, “parking is not allowed from 8 am to 6 pm” as derived from a parking traffic sign. In this way, OCR functionality or any other extraction of natural language characters may be triggered in response to any suitable event, such as detecting (e.g., via object detection) an object and/or determining whether the ego-machine falls below and/or exceeds a speed threshold.

Continuing with this example, responsive to the detection of the natural language characters from the traffic sign, particular embodiments provide such natural language characters as input into one or more machine learning model(s) such that the machine learning model(s) generates, as an output, other natural language characters associated with the environment (e.g., a natural language response indicating whether the current context permits parking in a detected parking space associated with the detected traffic sign) based at least on the detection of the natural language characters represented in the traffic sign. For example, the machine learning model(s) may include a Large Language model (LLM), where a representation of the detected natural language characters may be included in a prompt for the LLM. A prompt typically includes a natural language instruction (e.g., a query) and/or other natural language information, which causes the LLM to return a responsive natural language output. For instance, using the example above, the prompt may include one or more of: a zero-shot, one-shot, or few-shot examples of representative inputs and/or outputs, entity data (e.g., a tag) that describes particular entities in the natural language characters included in the traffic sign (e.g., as performed via Named Entity Recognition (NER)), a hierarchical data structure (e.g., a waterfall model) representing multiple features of the environment (e.g., each road and their connecting roads and traffic signs), a time of day during which elements representing the parking sign was detected, an indication of whether a parking spot is available (e.g., as determined via object detection or segmentation of visual data representing a parking space), and/or a query (e.g., “is it okay to park in this parking space”). The LLM may then ingest the prompt and responsively generate an output of natural language characters and/or words according to a confidence interval. Such output may be generated based on the LLM having been prompt-tuned, prompt-engineered, and/or fine-tuned to generate such output.

A representation of the LLM output (e.g., a visual indication of whether the detected traffic sign permits parking in a detected parking space at that time) may then be presented at a sound device or display device (e.g., an infotainment display) visible to an operator or occupant of the vehicle. The LLM output (e.g., generated natural language characters) may initially be in a text format. Accordingly, for instance, particular embodiments may use a text-to-speech module to process the natural language characters in order to present the natural language characters as audio data to a virtual assistant device built into the vehicle. For example, using the parking sign illustration above, the audio output at a sound device may be an utterance representing the generated natural language characters that states, “I'm sorry, but it looks like parking at this location is not permitted at this time. Although no car is in the parking space, the time is now 2 pm, which is before the allotted time (6 pm) allowed for parking according to the parking sign.”

Some systems and methods of this disclosure are further related to engaging the driver by presenting one or more generated natural language characters in response to detecting an alertness level of the driver or other events. For example, a Driver Monitoring System (DMS) camera in a steering column of a vehicle may employ an eye tracking module that sends out an infrared light that is reflected in the driver's eyes. Such reflections may be represented in image data picked up by cameras in the vehicle, where particular embodiments may, for example, detect pupil position, eye gaze, and the like. Such image data may alternatively or additionally include other information of any other portion of the driver, such pixel-level information showing head nodding, hands dropping, or whether the driver's eyes are open or closed. Based on image pattern characteristics in the image data, particular embodiments generate a score representing a first alertness level. For example, a model (e.g., a Convolutional Neural Network) may be fine-tuned to classify different alertness levels of the driver based on different positions of the driver indicated in images. For example, a model may adjust its weights during training to indicate that when a driver's eyes are closed, this is the lowest alert level. This may be based on labeling several training images of drivers with their eyes closed eyes as “lowest alert level 1” or other similar classification.

In some embodiments, such classification or score is mapped (e.g., via a hand-coded data structure) to any suitable alertness scoring system (e.g., represented in natural language or some other encoded input) so that it may be provided as an input into one or more LLMs or other model(s). For example, some embodiments map image data classifications to a Karolinska Sleepiness Scale (“KSS”), via a data structure, that contains (e.g., textual) representations of all 9 alert levels-“(1) extremely alert,” “(2) very alert,” “(3) alert,” “(4) rather alert,” “(5) nether alert nor sleepy,” “(6) some signs of sleepiness,” “(7) sleepy, but no effort to keep awake,” “(8) sleepy, some effort to keep awake,” and “(9) sleepy, great effort to keep awake, fighting sleep.” Some embodiments convert a computed alertness level to a corresponding (e.g., natural language phrase or other) representation of the computed alertness level, and provide that representation as (e.g., at least a portion of) an input into the machine learning model(s) such that the machine learning model(s) may generate corresponding natural language characters (e.g., a natural language response indicating that the operator's KSS level is 7 and/or some personalized natural language response, such as personalized trivia, to try and get the operator's KSS level lower).

In some embodiments, such generated natural language characters are processed using or provided to a text-to-speech module such that a presentation of such output of the natural language characters includes synthesizing audio data as a phrase utterance that initiates a conversation with the driver based at least on the score corresponding to the alertness level. For example, in response to detecting that the operator's alertness level was classified at or below/above a designated threshold (e.g., at a KSS level 9 alertness), the phrase utterance may be “WARNING: you are falling asleep. Would you like directions to the nearest hotel or rest area?” Some embodiments may (e.g., substantially simultaneously) send a control signal to a volume control device in the vehicle to cause the volume of such utterance to be high (e.g., at a predetermined decibel level) so as to engage the driver according to the alertness level detected. Such control signal may additionally or alternatively cause other tangible actions, such as honking a horn, slowing down/or stopping the car, and/or the like.

Some embodiments cause presentation of a natural language output predicted by one or more machine learning models based on detecting whether a driver did not see a traffic sign. Such detection may be based on analyzing the image data representing the traffic sign (e.g., as captured by the object detection camera) against the image data representing one or more portions of the driver (e.g., as captured by the DMS camera). For example, as described above, the eye tracking module may be used to detect eye gaze of the driver in a frame of image data associated with a particular time slice representing a time that the eye gaze was detected in order to determine what direction the driver was looking at a particular time stamp. For instance the eye gaze may indicate that the driver was looking straight ahead at a particular time, but a detected traffic sign may only have been viewable outside of the field of view associated with the detected gaze (e.g., through the passenger-side window) at that time.

Additionally, to facilitate detecting whether the driver (or other operator) noticed a detected traffic sign, particular embodiments may programmatically call, for example, a routine that accesses a waterfall data structure indicating one or more (e.g., all) features in the driving environment and their positions (e.g., all connecting road names, traffic signs, traffic lights, building structures, their orientation in space, and/or the like) and/or a geolocation indicator indicating where the vehicle was at a particular time slice. In this way, the eye gaze direction and timestamp may be correlated and/or intersected with the orientation of the detected traffic sign (e.g., as indicated in the waterfall structure, the geolocation indicator, and a corresponding timestamp). Accordingly, using the illustration above, because the driver's eyes were detected as looking forward in an associated frame, the vehicle was determined to be located near (e.g., within some designated threshold distance of) the traffic sign at that time slice, and/or the waterfall data structure indicates that the detected traffic sign was located on the right side of the road or to the right of the vehicle at that time slice, particular embodiments may generate a score (e.g., a confidence level) representing a likelihood that the driver did not see the detected traffic sign. Responsively, particular embodiments may provide a second indicator (e.g., a natural language phrase) of the second score as at least part of an input into the machine learning model(s), and the resulting action (e.g., the presentation of an output of corresponding natural language characters) may include a phrase that represents a response to the driver not seeing the traffic sign. For example, the score indicative of the likelihood that the driver did not see the traffic sign may originally be a binary classification (e.g., “0”) or other value indicating that the driver probably did not see the traffic sign. Particular embodiments may then responsively map, via a hand-coded data structure (e.g., a hash map), such score to a corresponding natural language input, such as “the driver did not see a stop sign.” Such a phrase may be placed in a prompt such that an LLM is prompt-tuned to output a phrase, such as “you just missed a stop sign. Please be careful. I'll notify you before you arrive at your next stop sign.”

Some embodiments may cause one or more machine learning models to output natural language characters based on a geo-location indicator. The geo-location indicator may represent a detected or otherwise obtained location of an ego-machine in the environment. For example, in some embodiments, the geo-location indicator represents geo-coordinates derived from a GPS module coupled to the vehicle or user device of a driver or other operator, which captures or otherwise updates the geo-coordinates of the device in a loop (e.g., every Nth interval, such as every 2 seconds). In another example, the geo-location indicator represents or includes a natural language identifier that represents a city, a state, or other area. In some of these embodiments, such identifier may be accessed in any suitable manner, such as object detection of real-world objects (e.g., a “welcome to Arizona” sign) and then responsively extract natural language characters included in the image data from which the real-world objects were detected, where the extracted natural language characters may represent an extracted geo-location indicator.

Based on the geo-location indicator, particular embodiments may determine weather data, road condition data, traffic data, and/or event data (e.g., an accident in an area) for that geo-location. For example, particular embodiments may access one or more data structures (e.g., a lookup data structure) indexed by city or other geographic unit. Accordingly, upon detecting what city the vehicle is in, particular embodiments may use the city identifier as an index in the data structure to read corresponding values in the same record and/or access an additional helper data structure or service of other values. For instance, based on looking up the city identifier, particular embodiments may then engage in a network communication session with a compute node representing a weather, traffic, road condition, and/or other event data service. Embodiments may transmit a query, which may include a request to return weather, traffic, and/or other event data for the specific city identifier. Application Programming Interface (API) logic may responsively fetch the weather, traffic, and/or other event data and return it back to the requesting compute node. Responsively, particular embodiments may then provide the weather, road condition, traffic data, and/or event data, as additional or alternative input into the machine learning model(s) such that the model presents additional or alternative natural language characters based on this input. For example, the initial input extracted from a weather service may be “City A, high: 90 degrees, low: 80 degrees.” After ingestion, the LLM may produce an output that states, “The temperature in this area is hot, with a high of 90 degrees.”

In some embodiments, the geo-location indicator is additionally or alternatively used to generate a summary of information included in a radio station broadcast associated with a particular geographic region. For instance, based on the geo-location indicator, particular embodiments may access first audio data associated with a radio station (e.g., by accessing a time-sequence of audio data over a network, such as the internet). Such time-sequence may be determined in any suitable manner, such as extracting the first X seconds or recognizing particular key words (e.g., via speech detection) or detecting pauses (a lack of sound) to begin and end the access of the audio data. For example, in response to recognition of the key word “weather,” particular embodiments may responsively initiate the extraction of audio data and then end when there is a threshold time between sounds (or threshold pause duration). Particular embodiments, may then convert, via speech-to-text, the first audio data into a textual representation (e.g., a document with natural language text). Particular embodiments may then provide such document (or some portion thereof) as an additional or alternative input into the machine learning model(s), where the model, such as an LLM, may then derives a summary of the relevant portion of the radio station broadcast.

Some embodiments generate natural language responses according to how an operator of an ego-machine verbally responds to such natural language response. For example, using the illustration above, particular embodiments receive a second phrase utterance representing a response by the driver, such as “no, I'll be okay” (which a driver utters responsive to the phrase utterance of, “WARNING: you are falling asleep. Would you like directions to the nearest hotel or rest area?”). Subsequently, some embodiments receive another set of image data representing one or more portions of the operator, such as through the DMS system described above. Based at least on image pattern characteristics of such image data and/or the second phrase utterance representing the response by the driver, particular embodiments generate a second score indicative of a second alertness level of the driver. For example, particular embodiments may use a Gaussian Mixture Model (GMM) or Hidden Markov Model (HMM) to detect the alertness level of the driver based on detecting voice patterns associated with alertness or non-alertness. GMMs, for example, may be used to differentiate between different utterance data of a single driver, such as what the driver sounds like when they are alert versus not alert. GMMs are models that include generative unsupervised learning or clustering functionality. For a given data set (e.g., voice utterances), each data point (e.g., a single utterance of multiple phenomes) is generated by linearly combining multiple “Gaussian” representations (e.g., multiple voice utterance sound distributions of the same user over time). A Gaussian representation is a type of distribution, which is a listing of outcomes of an observation and the probability associated with each outcome. For example, a Gaussian representation may include the frequency values over a time window of a particular utterance received and predicted frequency value over a next time window. The output is a predicted class, such as determining or predicting whether two different Gaussian distributions or utterances are indicative of alertness or drowsiness, based on a baseline of recorded driver utterances where the driver was not drowsy and/or a baseline of recorded driver utterances where the driver was drowsy. Such indications may then be mapped as the second score indicating the alert level.

Responsively, particular embodiments provide a second representation (e.g., another natural language phrase) of the second score as input into the machine learning model such that the model generates and presents additional natural language characters that represents yet another phrase utterance in the conversation with the driver. For example, the presented output might be, “you still sound kind of tired. I'm going to call your wife if that's okay?” Such output may be based on receiving input via a GMM that has classified the driver phrase as 1 (representing very drowsy) and a hand-coded data structure that maps such classification into a natural language phrase, such as “driver is very drowsy.”

Some embodiments additionally or alternatively engage in the conversation with the operator based on accessed personalized information. For example, some embodiments access, from a database or other data store, trivia games according to what a driver's interests are (e.g., football trivia). In some instances, before driving a vehicle, the driver may have previously uploaded and registered their interests using natural language (e.g., “I really like football”) to the database for later reference during driving. Responsively, particular embodiments provide such natural language personalized information as an input into the machine learning model such that the conversation with the driver is additionally or alternatively based on the personalized information associated with the driver. For example, such output may be, “do you know the name of the only football player to score 10 rushing touchdowns in a game?” based on the driver's football interests and based on detecting the driver's alertness level.

As such, operator assistance may be provided based on using one or more language models (e.g., a Large Language Model (LLM)) to generate a natural language response. Some embodiments relate to providing-context specific information to an operator as part of a natural language dialogue or other natural language output. Additionally or alternatively, some embodiments relate to engaging the operator (e.g., via a relevant conversation) based on operator monitoring.

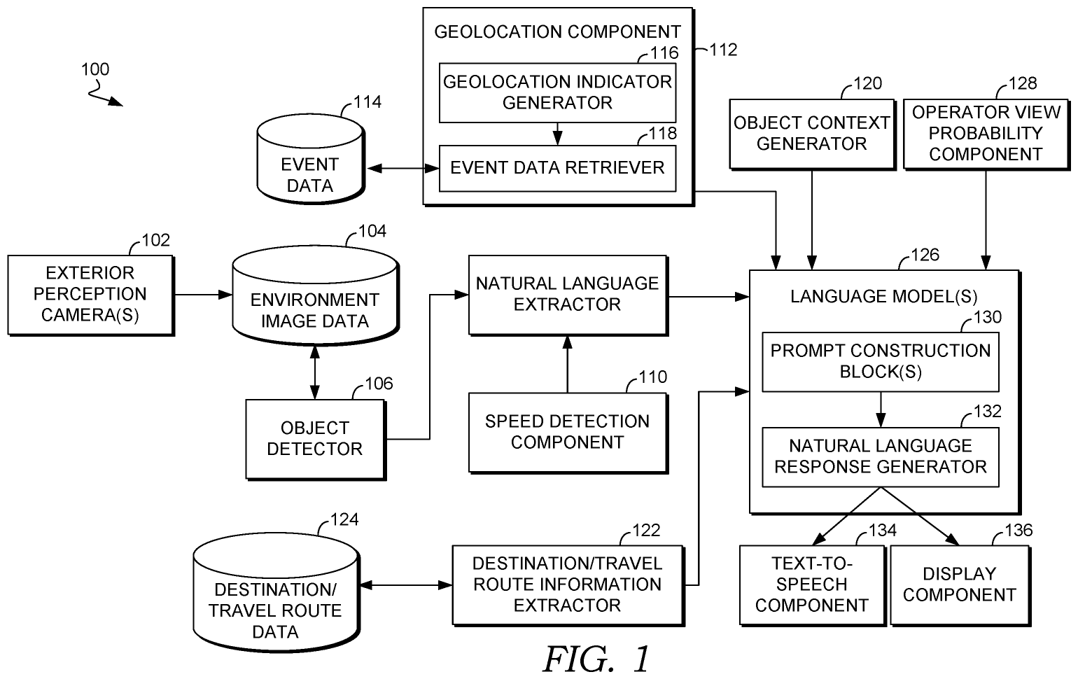

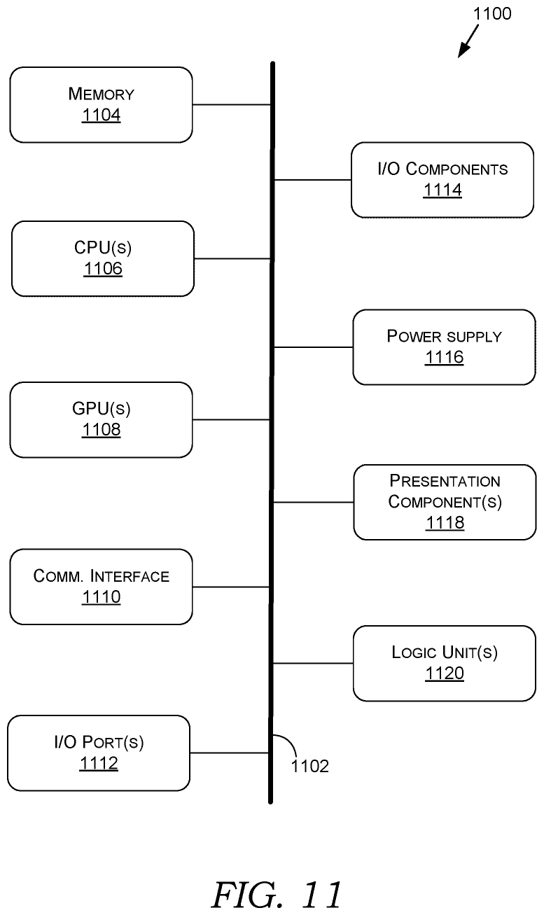

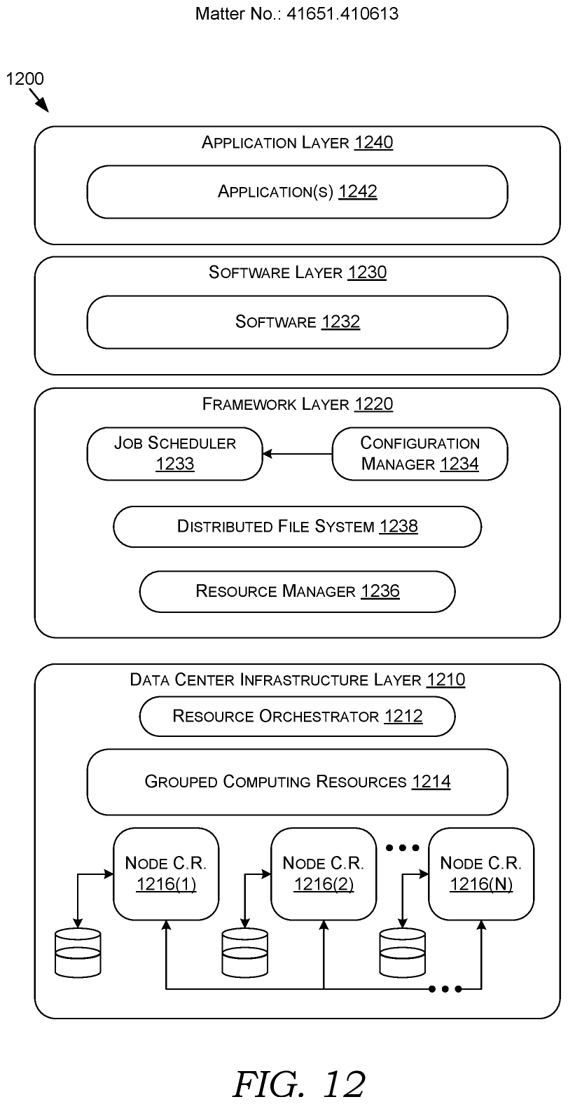

With reference to FIG. 1, FIG. 1 is an example natural language extraction pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 1000 of FIGS. 10A-10D, example computing device 1100 of FIG. 11, and/or example data center 1200 of FIG. 12.

In the embodiment illustrated in FIG. 1, the natural language extraction pipeline 100 includes an exterior perception camera 102, an object detector 106, a natural language extractor 108, a speed detection component 110, a geolocation component 112, an object context generator 120, a destination/travel route information extractor 122, an operator view probability component 128, one or more language models 126, a text-to-speech component 134, a display component 136, environment image data 104, event data 114, and destination/travel route data 124.

The exterior perception camera(s) 102 may be responsible for capturing one or more images (e.g., a video segment) of an environment, such as outside of an ego-machine (e.g., a vehicle, an aircraft, a water-based vessel (e.g., a ship), a drone, or the like). For example, a video camera mounted on top of a car, or within the car, may use optics to focus light onto an image sensor within the camera, which converts light into electrical signals that are processed and stored as digital image files. The video camera may capture and record a particular image (also referred to as a frame) in succession with other images and then present the sequence of images to create an indication of motion. For example, the video camera may generate a sequence of image data of a driving environment that includes streets, street signs, traffic lights, pedestrians, or the like. The output of the exterior perception camera(s) 102 is the environment image data 104. The environment image data 104 may include one or more digital images or frames, such as a sequence of frames indicative of a video feed.

The object detector 106 may be responsible for determining one or more objects within the environment image data 104. In some embodiments, the object detector 106 performs its functionality via object detection and/or semantic segmentation (e.g., panoptic segmentation). Semantic segmentation refers to the task of assigning and indicating (e.g., via a unique pixel-wise mask color or ID) each pixel to a particular class of a real-world object or background represented in an input image. For example, semantic segmentation functionality may define a first set of pixels of the environment image data 104 as representing a “bird” and a second set of pixels as also representing a “bird,” where both birds are represented by the same mask pixel value. In some embodiments, instance segmentation is additionally or alternatively performed. Instance segmentation may assign and define, with a unique identifier, each pixel to the instance of the real-world object the pixel corresponds to. For example, using the illustration above, the first set of pixels representing the first bird may be assigned an instance ID of 1 and a first color mask pixel value. Likewise, the second set of pixels representing the second detected bird may be assigned an instance ID of 2 and/or different mask color pixel value.

Semantic segmentation may be implemented using a deep learning algorithm that associates a label or category with every pixel in an image. Some embodiments label each pixel of an image with a corresponding class of what is being represented. This is used to recognize a collection of pixels that form distinct categories. For example, a model may be trained to mask objects with pixel values of vehicles, pedestrians, traffic signs, pavement, or other road features. For example, a Convolutional Neural Network (CNN) may perform image-related functions at each layer and then down-sample the image using a pooling layer (e.g., green). This process is repeated several times for the first half of the network. The output from the first half of the network may be followed by an equal amount of unpooling layers (e.g., orange).

In some embodiments, semantic segmentation may be performed via panoptic segmentation. The combination of semantic segmentation and instance segmentation is what is referred to as panoptic segmentation. Specifically, in panoptic segmentation, some or all pixels of an image may be uniquely assigned to one of the background classes or one of the object instances. For object instances, panoptic segmentation functionality may thus classify each pixel in an image as belonging to a particular class and identify what instance of the class the pixel belongs to. For background classes, panoptic segmentation may perform similar functionality as semantic segmentation.

In some embodiments, the object detector 106 additionally or alternatively performs object detection or classifying one or more objects in an input image. In an illustrative example of object detection functionality, particular embodiments use one or more machine learning models (e.g., a CNN) to generate a bounding box that defines the boundaries and encompasses a computer object representing a feature (e.g., a car, the sky, a building, a person, etc.) in an image. These machine learning models may generate a classification prediction that the computer object is a particular feature. In computer vision applications, the output of object detection may be encompassed by a bounding box or other bounding shape. A bounding box may encompass the predicted boundaries of the object in terms of the position (e.g., 2-D or 3-D coordinates) of the bounding box (and also the height and width of the bounding box). For example, the bounding box may be a rectangular box that is determined by its X and Y axis coordinates. This gives object recognition systems indicators of the spatial distinction between objects to help detect the objects in images. In an illustrative example, on an image, a first bounding box encompassing a car in an image may be generated and labeled as “car,” a second bounding box encompassing a traffic sign may be generated and labeled “traffic sign,” and a third bounding box encompassing a mountain objects may be generated and labeled as “mountain.”

In some embodiments, one or more machine learning models may be used and trained to generate tighter bounding boxes for each object. In this way, bounding boxes may change in shape and confidence levels for classification/prediction and may be increased based on increased training sessions. For example, the output of a CNN or any other machine learning model described herein may be one or more bounding boxes over each object feature (corresponding to a feature in an image), where each bounding box includes the classification prediction (e.g., this object is a building) and the confidence level (e.g., 90% probability).

In some embodiments, the object detector 106 additionally or alternatively performs image classification, object recognition, keypoint detection, edge detection, and/or other functionality where different features or objects are identified in an image. For example, with respect to image classification, embodiments may perform pixel-based classifications (e.g., minimum-distance-to-mean, maximum-likelihood, and minimum-Mahalanobis-distance) or object-based classifications to classify an entire image (without determining location information, such as a bounding box). For example, some embodiments perform pre-processing operations, such as converting the image into a vector or matrix, where each value (e.g., an integer or float) represents a corresponding pixel value in the image. In some embodiments, such as in K-Nearest Neighbor (KNN) use cases, particular embodiments determine the distance between such vector and other vectors that represent training images, where the closest vectors indicate that a set of pixels (or the entire image) corresponds to a certain class.

The speed detection component 110 may be responsible for detecting a speed or velocity of an ego-machine and returning an indication of such speed to the natural language extractor 108. For example, the speed detection component 110 may be included in a Wheel Speed Sensor (ABS Sensor), Vehicle Speed Sensor (VSS), Global Positioning System (GPS), Radar and Lidar, a Wheel Tachometer, or the like in order to detect a speed (e.g., in miles per hour) of an ego-machine.

The natural language extractor 108 may be responsible for taking, as input, the determined object(s) from the object detector 106, and/or an indication of the speed from the speed detection component 110, which triggers the extraction of one or more natural language characters from the environment image data 104. For example, using the speed data from the speed detection component 110 as input, the natural language extractor 108 may determine whether a vehicle is below and/or exceeds a threshold speed (e.g., is above 5 miles per hour and/or below 50 miles per hour). Such selective extraction ensures that image data processing resources are not unnecessarily consumed. For instance, if a vehicle is at a complete stop there may no need to extract text from objects. Likewise, if the vehicle is going too fast, embodiments do not extract characters because there is more likely going to be extraction errors and/or because the extraction may not be as useful since the driver may have passed corresponding objects well before they get extraction data returned. At least partially responsive to the vehicle falling below and/or exceeding the speed threshold, the natural language extractor 108 may extract natural language characters within the one or more regions of image data representing the detected object(s). Additionally or alternatively, using the image data returned by the object detector 106, the natural language extractor 108 may determine (e.g., via edge detection) whether there are natural language characters represented in such object(s). At least partially responsive to the determining that there are natural language characters represented in such objects, the natural language extractor 108 extracts natural language characters within the one or more regions of image data representing the detected object(s).

The natural language extractor 108 may use any suitable functionality for extracting natural language characters from an object. For example, Optical Character Recognition (OCR), Handwritten Text Recognition (HTR), Intelligent Character Recognition (ICR), Template Matching, Rule-based Information Extraction, and/or other suitable functionality may be used. For example, the natural language extractor 108 may represent OCR functionality that encodes elements of the image data into machine-readable natural language text via pattern matching or feature extraction methods. In some embodiments, OCR includes the following functionality: an OCR component may perform image quality functionality to change the appearance of the image data 104 by converting one or more color image frames to greyscale, performing desaturation (removing color), changing brightness, changing contrast for contrast correctness, and/or the like. Responsively, the OCR component may perform a computer process of rotating one or more image frames to a uniform orientation, which is referred to as “deskewing” the image. In some instances, image frames are slightly rotated or flipped in either vertical or horizontal planes and in various degrees, such as 45, 90, and the like. Accordingly, some embodiments deskew the image to change the orientation of the image for uniform orientation (e.g., a straight-edged profile or landscape orientation). In some embodiments, in response to the deskew operation, some embodiments remove background noise (e.g., via Gaussian and/or Fourier transformation). In many instances, one or more image frames contain unnecessary dots or other marks. In order to be isolated from the distractions of this meaningless noise, some embodiments clean the images by removing these marks. In response to the removing the background noise, some embodiments extract the natural characters from the image and place the extracted characters in another format, such as JSON. Formats, such as JSON, may be used as input for other machine learning models, such as the language model(s) 126 (e.g., a LLM), as described in more detail below.

The geolocation component 112 may be responsible for generating a geolocation indicator that represents a location of an ego-machine in an environment and determining event data, such as weather data, road condition data, traffic data and/or any other event data (e.g., indications of traffic accidents) associated with the geolocation indicator. The geolocation component 112 includes a geolocation indicator generator 116 and an event data retriever 118. The geolocation indicator generator 116 may be responsible for generating or determining the geolocation indicator and returning it to the event data retriever 118 for further processing. In some embodiments, the geolocation indicator generator 116 generates the geolocation indicator via any suitable method. For example, the ego-machine (and/or user device of an operator of the ego-machine) may have a built-in GPS module that triangulates or uses trilateration to determine its coordinates based on received signals from one or more satellites, where the coordinates represent the geolocation indicator.

Alternatively or additionally, a speech-to-text component in an ego-machine may encode audio data representing a radio station and/or user utterances into natural language characters, where such natural language characters may indicate the ego-machine's location (e.g., “wow, the Grand Canyon is more beautiful than I thought.” Responsively, Natural Language Processing (NLP), such as NER and semantic analysis may be performed to determine that the natural language characters indicate the geographic region the user is located in, where such natural language characters represent the geolocation indicator. Alternatively or additionally, beacon technologies, magnetic positioning, dead reckoning, and/or the like may be used to generate the geolocation indicator.

The event data retriever 118 may be responsible for fetching any suitable event data 114 based on using the generated geolocation indicator from the geolocation indicator generator 116 as input. For example, using the geolocation indicator as an index in a lookup data structure, the event data retriever 118 may locate one or more corresponding records in event data 114 that specify weather data (e.g., temperature high and low, barometric pressure, wind chill, etc.), road condition data (e.g., a state of a road, such as an indication that one or more roads are icy, are paved, are dirt roads, etc.), traffic data (e.g., an indication of what the waiting time will be from different segments of one or more streets based on traffic), and/or other event data (e.g., an indication of car accidents, an indication of a big sporting event) within a geographical area (e.g., a zip code, geo-coordinates) represented by the geolocation indicator.

In some embodiments the event data 114 may include or represent audio data of one or more radio stations, as described herein. Audio data may be used in conjunction with other event data, such as weather alerts and geo-based alert mechanisms. In this way, for example, the natural language response generator 132 summarizes alerts and broadcasts messages (e.g., radio station messages) based on certain unexpected events, road closures, and/or the like.

In some embodiments, the event data 114 may represent one or more remote data sources of one or more network devices that are accessible via an Application Programming Interface (API) such that, for example, the event data retriever 118 establishes a communication session (e.g., via network handshaking) with the network device and responsively opens up a network communication channel so that the network device may return the event data 114 to the even data retriever 118 via the API. The event data retriever 118 is additionally responsible for providing a representation of the derived event data 114 to the language model(s) 126 as input, as described in more detail below.

The object context generator 120 may be responsible for collecting or determining metadata, such as context associated with one or more objects detected by the object detector 106. For example, if a detected object includes a parking sign, embodiments may extract parking context, such as a time of day and/or a day of week, that the object detector 106 performed its functionality (e.g., as automatically populated in a log file of a video image), an ego-machine type of the ego-machine (e.g., based on an ego-machine having broadcast its ID), and/or an indication of whether a parking spot is available for parking (e.g., as at least partially determined by performing object detection or segmentation functionality on image data representing a parking spot). Alternatively or additionally, other metadata may include travel route, destination, health data (e.g., as manually registered by an operator), and/or the like. The object context generator 120 is additionally responsible for returning a representation of its output to the language model(s) 126, which may use this data as an input, as described in more detail below.

The operator view probability component 128 may be responsible for detecting whether an operator of the ego-machine saw one or more objects detected by the object detector 106. For example, in some embodiments, the operator view probability component 128 includes a DMS that works in conjunction with the object detector 106. Accordingly, for example, the functionality of the operator view probability component 128 may be based on analyzing image data representing a traffic sign (e.g., as indicated by the object detector 106)) against image data representing one or more portions of the driver (e.g., as captured by the DMS camera). For instance, as described above, the eye tracking module may be used to detect eye gaze of the driver in an image and a time stamp that the eye gaze was detected in order to determine in which direction the driver was looking at a particular timestamp. For instance, the gaze may indicate that the driver was looking out of a side view mirror at a first time, but a traffic sign may have been viewable straight ahead out of the windshield at the first time. A “traffic sign” as described herein may refer to a traffic light, such as a green light, red light, or yellow light. Alternatively or additionally, a traffic sign may refer to any visual device or symbol placed alongside or above roads, streets, or highways to convey specific information, regulations, warnings, or guidance to drivers, pedestrians, and other road users. For example a traffic sign may be a stop sign, a school zone traffic sign, a parking sign, or the like.

Additionally or alternatively, the operator view probability component 128 may programmatically call, for example, a routine that accesses a waterfall data structure indicating all features in the driving environment and their positions (e.g., all connecting road names, traffic signs, traffic lights, building structures, and their orientation in space) and/or the geolocation indicator (generated by the geolocation indicator generator 116) indicating where the vehicle was at the first time. In this way, the eye gaze direction and timestamp may be correlated or intersected with the orientation of the particular traffic sign as indicated in the waterfall structure as well as the geolocation indicator and corresponding timestamp. Accordingly, using the illustration above, because the driver's eyes were detected as looking at the side-view mirror at a first time, and the vehicle was near the traffic sign at the first time, and the waterfall data structure indicates that the traffic sign was straight ahead about 10 yards away at the first time, particular embodiments generate a score (e.g., a confidence level) that the driver did not see the traffic sign. Responsively, as illustrated in FIG. 1, particular embodiments provide a representation of the score as an input into the language model(s) 126, as described in more detail below.

The destination/travel route information extractor 122 may be responsible for accessing, from the destination/travel route data 124, destination or travel route information associated with a destination or travel route of the ego-machine and responsively provide a representation of the destination or travel route information as at least a portion of input into the language model(s) 126. For example, in response to detecting a travel route or destination of the vehicle (e.g., via user input of such data or detecting, via an LLM and in a conversation, a driver utterance that includes natural language words describing the road that will be taken to get to the destination), particular embodiments, may extract videos, photos, or raw natural language text from a user device or over a public computer network (e.g., the internet) associated with the information. For instance, based on detecting that the route includes the city of Tusayan Arizona, particular embodiments access, over a computer network, a dataset of images or other data in 124 and detect (e.g., via object detection) all images of the Grand Canyon based on ingesting information that indicates the Grand Canyon is near Tusayan and also extract natural language characters that describe various landmarks along the travel route, as accessed at various public web-pages via a query. According, such natural language characters may then be provided to the language model(s) 126 as an input where the language model(s) 126 summarizes each landmark that the driver will come across in a journey.

Additionally or alternatively, some embodiments may cause display, e.g., by using a display device in the ego-machine, of the extracted images of the Grand Canyon, other images (e.g., in the image data 104), or natural language representations. Some embodiments may provide images (e.g., as detected by the exterior perception camera(s) 102) as input to a multi-modal machine learning model (e.g., Contrastive Language-Image Pretraining (CLIP)), which encodes the images into natural language text that describes the images or different features in the image. For example, given an image of the Grand Canyon, CLIP may generate a confidence score and predict a text output, which represents the most relevant text description that describes the Grand Canyon (e.g., “this is a picture of the Grand Canyon”). In this way, the text description may be supplied to the language model(s) 126, where the language model may generate, via the natural language response generator 132, an output. An example output generated by a language model(s) 126 in response to an text description may include, for example, “Did you know that the Grand Canyon is not the deepest canyon in the world, but it is often considered one of the most visually stunning? The Grand Canyon is approximately 6,000 feet (1,800 meters) deep at its deepest point, while the Yarlung Tsangpo Grand Canyon in Tibet is even deeper, plunging to depths of over 17,000 feet (5,200 meters).”

The language model(s) 126 may be responsible for taking one or more of the inputs (or partial inputs) provided by the destination/travel route information extractor 122, the natural language extractor 108, the operator view probability component 128, the object context generator 120, and/or the geolocation component 112 in order to generate one or more corresponding natural language outputs. In some embodiments, the language model(s) 126 represents one or more machine learning models or other models that perform NLP. In some embodiments, a “language model” is a set of statistical or probabilistic functions that (e.g., collectively) performs Natural Language Processing (NLP) in order to understand, learn, and/or generate human natural language content. For example, a language model may be a tool that determines the probability of a given sequence of words occurring in a sentence (e.g., via NSP or MLM) or natural language sequence. Simply put, it may be a tool which is trained to predict the next word in a sentence or other natural language character set.

A language model is referred to as a large language model (“LLM”) when it is trained on enormous amounts of data. Some examples of LLMs are GOOGLE's BERT and OpenAI's family of generative pre-trained transformer (GPT) networks, which include GPT-2, GPT-3, and GPT-4. GPT-3, for example, includes 175 billion parameters trained on 570 gigabytes of text. These models have capabilities ranging from writing a simple essay to generating complex computer codes-all with limited to no supervision. Accordingly, an LLM is a deep neural network that is very large (e.g., billions to trillions of parameters) and understands, processes, and produces human natural language from being trained on massive amounts of text. These models predict future words in a sentence based on sentences in the corpus of text they were trained on, letting them generate sentences which can be similar to how humans talk and write. In some embodiments, the LLM is pre-trained (e.g., via NSP and MLM on a natural language corpus to learn English), prompt-tuned, fine-tuned, and/or functions via prompt engineering, as described in more detail below.

In some embodiments, at least one of the language model(s) 126 is stored locally at a network device or node within the ego-machine. This may be useful to keep processing locally where real-time decisions need to be made while the operator is driving, for example. In these contexts, a reduction in processing latency is desired in order to meet the time constraints related to near real-time operator driving and tasks, such as extracting natural language characters from a traffic sign to inform the operator of the contents of the traffic sign. Alternatively or additionally, in some embodiments, at least one of the language model(s) 126 is hosted at a remote device, such as a cloud node or central server. In these embodiments, for example, such cloud node or central service may be contacted via a network (e.g., the internet) in order to provide model outputs. Such network architecture may be useful where, for example, heavy data processing is required or lots of data is stored.

The language model(s) 126 includes one or more prompt construction blocks 130 and a natural language response generator 132. The prompt construction block(s) 130 may be responsible for generating (e.g., automatically) or receiving one or more natural language instructions based on the input received from the destination/travel route information extractor 122, the natural language extractor 108, the geolocation component 112, the object context generator 120, and/or the operator view probability component 128. The prompt construction lock(s) 130 generates natural language characters (or representations thereof, such as a soft prompt) as input into the language model(s) 126 such that the natural language response generator 132 generates, as an output, other natural language characters associated with the environment (e.g., a natural language response indicating whether the current context permits parking in a detected parking space associated with the detected traffic sign) based at least on inputs received from the destination/travel route information extractor 122, the natural language extractor 108, the geolocation component 112, the object context generator 120 and/or the operator view probability component 128.

In some embodiments, the natural language response generator 132 performs text translation. Text Translation is the process of translating natural language from one language (e.g., Chinese) to another (e.g., English). Various embodiments provide a sentence or a block of text in one language as input or prompt via the prompt construction block(s), and the model will generate the corresponding translation in the desired target language. For instance, the natural language characters extracted and passed from the natural language extractor 108 may be in a first language, which may then get translated to a second language. In an illustrative example, the natural language response generator 132 may translate first OCR text (in a first language) from traffic signs in a first country to a second language corresponding to a second country.

In an illustrative example, the prompt generated by the prompt construction block(s) 130 may include a zero-shot, one-shot, or few-shot examples of representative input-output pairs. As described herein, in some embodiments, an “example” refers to one or more model (e.g., representative or exemplary) inputs and/or outputs associated with the request, where the “model output” at least partially indicates how the output should be formatted (e.g., via sentence structure or syntax, word choices, length (e.g., number of words) in the output, etc.) according to an example input. In some embodiments, an “example” refers to natural language content that a model uses as a guide for structuring or styling its output and the model typically does not use the example as a guide for deriving substantive natural language text (e.g., the subject or object in a sentence) in the example to copy over to the output. For example, if an instruction is to “inform the operator that she missed a traffic sign,” an example is an input-output pair, such as a stop sign (or natural language description of the stop sign) (the example input) and “Jane, you just missed a stop sign . . . ” (the example output). The output may say something like, “Jack, you just missed a stop sign.” Accordingly, the examples were used for the output's format and style “you just missed a stop sign . . . ” (i.e., various syntactical and introductory words were copied to the output, but not all words were copied over, such as “Jane”) given the stop sign in the input. The name was changed (from Jane to Jack).

In some embodiments, the prompt includes entity data, such as a tag that describes particular entities in the natural language characters in the detected object(s). For example, the tag may be generated via Named Entity Recognition (NER). NER is an information extraction technique that identifies and classifies tokens/words or “entities” in natural language text into predefined categories. Such predefined categories may be indicated in corresponding tags or labels. Entities may be, for example, names of people, specific organizations, specific locations, specific times, specific quantities, specific monetary price values, specific percentages, specific pages, and the like. Likewise, the corresponding tags or labels may be specific people, organizations, location,” time, price (or other invoice data) and the like. In an illustrative example of NER functionality, if NER tags an entity (e.g., Thomas Edison) as a “name entity,” this triggers a certain phrase in the prompt, such as “deer [animal] Xing [place where deer cross]” where the information in the brackets represents NER entities to be included in the prompt.

The language model(s) 126 may ingest the prompt and responsively generate, via the natural language response generator 132, an output of natural language characters and/or words according to a confidence interval. In an illustrative example of the language model(s) 126 functionality, the operator view probability component 128 may generate a score indicative that the driver did not see a traffic sign-a binary value (e.g., a “0”) or other value indicating that the driver did not see the traffic sign. The operator view probability component 128 may then responsively map, via a hand-coded data structure (e.g., a hash map), such a score to a natural language input, such as “the driver did not see a stop sign.” Such a phrase may responsively be returned to the prompt construction block(s) 130 to be placed in a prompt such that an LLM is prompt-tuned to output a phrase, via the natural language response generator 132, “you just missed a stop sign. Please be careful. I'll notify you before you arrive at your next stop sign.” Examples of various natural language inputs, prompts, and outputs are described in more detail below.

The text-to-speech component 134 may be responsible for converting, via speech-to-text functionality, written or visual natural language characters produced by the natural language response generator 132 into corresponding audio data that represents the written or visual natural language characters. In these embodiments, such audio data may be presented at a sound device (e.g., a voice assistant speaker or a stereo system), which may be helpful so that an ego-machine operator is able to keep their eyes on the road without having to read text. The display component 136 may be responsible for transmitting the written or visual natural language characters produced by the natural language response generator 132 to a display device (e.g., an LCD screen memory), such as a display screen in an ego-machine. In this way, the operator may alternatively or additionally view or read the produced outputs.

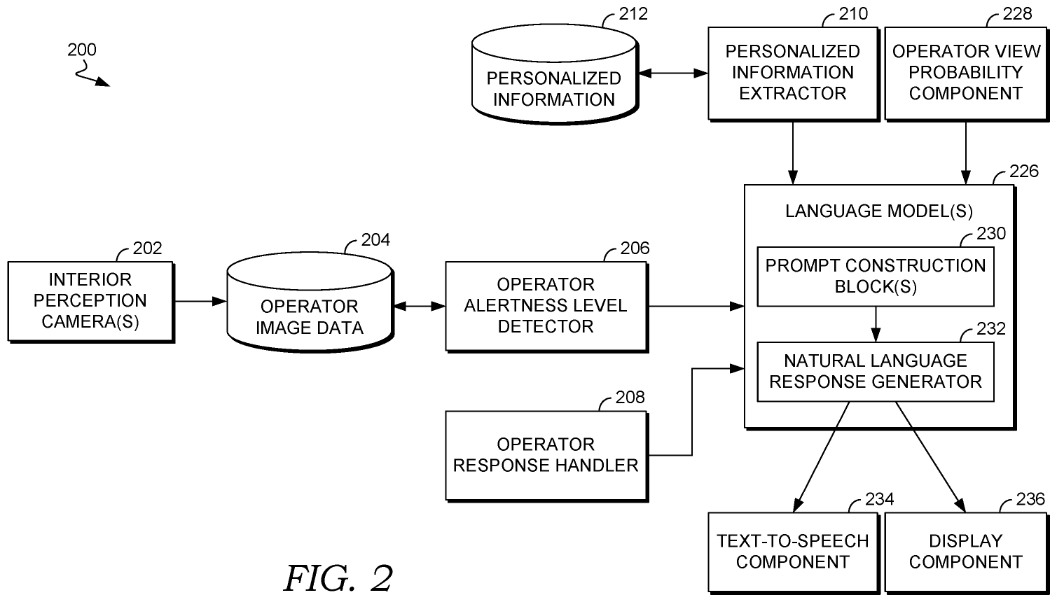

With reference to FIG. 2, FIG. 2 is an example alertness level detector pipeline 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In some embodiments, the alertness level detector pipeline 200 includes one or more components of the natural language extraction pipeline 100 of FIG. 1. For example, in some embodiments, FIG. 2 includes the exterior perception camera(s) 102, the environment image data 104, the object detector 106, the speed detection component 110, the destination/travel route information extractor 122, the geolocation component 112, and/or the object context generator 120. In some embodiments, the language model(s) 226 represent the same language model(s) 126 of FIG. 1. In some embodiments, the systems, methods, and processes described herein may be executed using similar components, features, and/or functionalities to those of example autonomous vehicle 1000 of FIGS. 10A-10D, example computing device 1100 of FIG. 11, and/or example data center 1200 of FIG. 12.

In the embodiment illustrated in FIG. 2, the alertness level detection pipeline 200 includes an interior perception camera(s) 102, operator image data 204, an operator alertness level detector 206, an operator response handler 208, a personalized information extractor 210, personalized information 212, one or more language models 226, an operator view probability component 228, a text-to-speech component 234 and the display component 236.

The interior perception camera(s) 202 may be responsible for capturing one or more images (e.g., a video segment) of one or more portions of an interior section of an ego-machine—which may include an operator of the ego-machine—and then responsively storing the image(s) as operator image data 204. For example, the interior perception camera(s) 202 may be included in a DMS, which relies on cameras and sensors positioned strategically within a vehicle cabin. In some embodiments, the interior perception camera(s) 202 are located on the dashboard, rearview mirror, or other suitable locations. In some embodiments, the interior perception camera(s) 202 includes an infrared camera for nighttime operation. In this way, for example, sensors within the DMS may capture images of the interior and store them, in a data store, as the operator image data 204.

The operator image data 204 is a data store of one or more images of the interior portion(s) of the ego-machine and/or operator within the ego-machine. For example, the operator image data 204 may be various streamed video sequences of an interior portion of an ego-machine at various time stamps. The operator alertness level detector 206 detects the alertness level of the operator of the ego-machine based on detecting patterns or associations within the operator image data 204. For example, a DMS may employ computer vision and facial recognition algorithms to monitor the operator's face (or operator image data 204 representing the operator's face) in or near real-time. It tracks key facial features such as the eyes, eyelids, mouth, and/or head position. Additionally or alternatively, a DMS may incorporate eye-tracking technology to monitor a driver's eye movement. For example, it may track factors like blink rate, gaze direction, and eyelid closure duration. The DMS alternatively or additionally monitors the operator's head position and movements. Sudden jerks or unusual head positions may be signs of distraction or drowsiness.

The operator alertness level detector 206 is also generally responsible for providing a representation (e.g., a natural language sentence) of the alertness level to the language model(s) 226 for further processing, as described in more detail below. For example, the operator alertness level detector 206 may use an alertness level score as an index in a data structure to look up corresponding hand-coded natural language characters, such as “this operator has the highest alert level possible in the KSS scale.”

The operator response handler 208 may be responsible for receiving and handling all operator responses and providing representations of such operator responses as at least a partial input to the language model(s) 226. For example, after an alertness level of the operator has been detected via the operator alertness level detector 206, it may feed a representation of the score as input into the language model(s) 226, which then produces a natural language response, “you are getting really tired, should I call your spouse?” Subsequently, the operator response handler 208 receives a phrase utterance representing a response by the driver, such as “no, I'll be okay.” Subsequently, in some embodiments, the operator alertness level detector 206 receives another set of image data representing one or more portions of the driver, such as through the DMS system described above. Based at least on image pattern characteristics of such image data and/or an operator response/utterance handled by the operator response handler 208, particular embodiments generate a second score indicative of a second alertness level of the driver. In an illustrative example, particular embodiments may use a Gaussian Mixture Model (GMM) or Hidden Markov Model (HMM) to detect the alertness level of the driver based on detecting voice patterns associated with alertness or non-alertness, as described above.

Responsively, particular embodiments provide another representation (e.g., another natural language phrase) of the second score as input into the language model(s) 226 such that the model generates and presents additional natural language characters that represents yet another phrase utterance in a conversation with the operator. For example, the presented output might be, “you still sound kind of tired. I'm going to call your wife if that's okay?” Such output may be based on receiving input via a GMM that has classified the driver phrase as 1 (representing very drowsy) and a hand-coded data structure that maps such classification into a natural language phrase, such as “driver is very drowsy.”

The personalized information extractor 210 may be responsible for extracting personalized information 212 and providing a representation of such information as at least a partial input into the language model(s) 226. For example, some embodiments access, from the personalized information 212, indications that the operator likes science and plays tennis as a hobby. Responsively, particular embodiments provide such natural language personalized information as an input into the language model(s) 226 such that a conversation with the operator is additionally or alternatively based on the personalized information associated with the driver. For example, such output as generated by the natural language response generator 232 may be, “your favorite tennis player is playing today,” based on the driver's tennis interests and based on the driver's alert level being below a threshold.

The language model(s) 226 may be responsible for taking one or more of the inputs (or partial inputs) provided by the operator alertness level detector 206, the operator response handler 208, the personalized information extractor 210, and/or the operator view probability component 228 in order to generate one or more corresponding natural language outputs. The language model(s) 226 includes the prompt construction block(s) 230 and the natural language response generator 232. In some embodiments, the prompt construction block(s) 230 and the natural language response generator 232 represents the same functionality relative to the prompt construction block(s) 130 and natural language response generator 132 respectively for FIG. 1, except that the instructions or prompts and outputs are specifically tailored to the outputs produced by the operator response handler 208, the operator alertness level detector 206, the personalized information extractor 210, and/or the operator view probability component 228.

In an illustrative example of the prompt construction block(s) 230, it may include natural language personalized interests as returned by the personalized information extractor 210, a zero-shot, one-shot, or few-shot examples of example conversations that the operator (or another operator) has had with the language model(s) 226 given various example inputs, a natural language instruction to “start a conversation that aligns with the operator interests,” a natural language description of the operator's alertness level (e.g., via KNN scale), as returned by the operator alertness level detector 206, the operator's natural language response as provided by the operator response handler 208, and/or a natural language description of whether the operator saw or did not see one or more detected objects, as returned via the operator view probability component 228. The natural language response generator 232 then responsively generates one or more natural language responses. For example, the natural language response generator 232 may generate a natural language sentence that reads, “Wake up! And let's play football trivia together” (based on inputs provided by the operator alertness level detector 206 and the personalized information extractor 210).

In some embodiments, the operator view probability component 228 includes the same functionality as the operator view probability component 128. Likewise, in some embodiments, the text-to-speech component 234 and the display component 236 represents the same respective functionality as described with respect to the text-to-speech component 134 and display component 136 of FIG. 1.

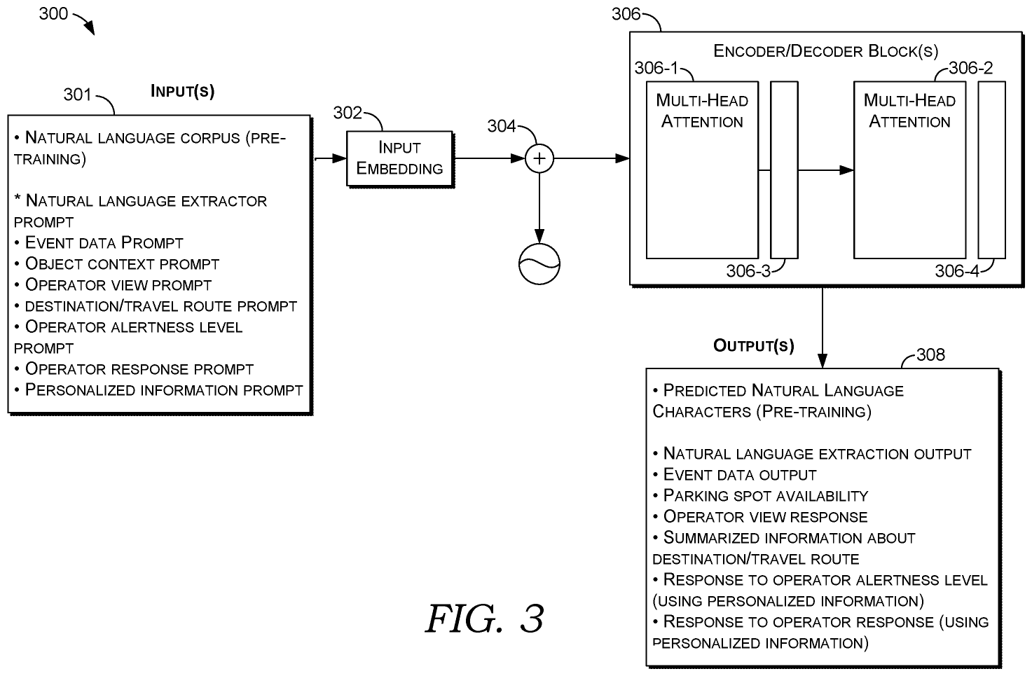

FIG. 3 is a block diagram of a Large Language Model 300 (e.g., a BERT model or GPT-4 model) that uses particular inputs to generate particular natural language responses, according to some embodiments. In some embodiments, this model 300 represents or includes the functionality as described with respect to the language model(s) 126 and/or language model(s) 226 of FIG. 1 or 2 respectively. In various embodiments, the language model 300 includes one or more encoders and/or decoder blocks 506 (or any transformer or portion thereof).

At a first time, the inputs 301 are converted into tokens and then feature vectors and embedded into an input embedding 302 (e.g., to derive meaning of individual natural language words (for example, English semantics) during pre-training). In some embodiments, each word or character in the input(s) 301 is mapped into the input embedding 302 in parallel or at the same time, unlike existing long short-term memory (LSTM) models, for example. The input embedding 302 maps a word to a feature vector representing the word. But the same word (for example, “apple”) in different sentences may have different meanings (for example, a device versus a piece of fruit). This is why a positional encoder 304 may be implemented. A positional encoder 304 is a vector that gives context to words (for example, “apple”) based on a position of a word in a sentence. For example, with respect to a message “I just sent the document,” because “I” is at the beginning of a sentence, embodiments may indicate a position in an embedding closer to “just,” as opposed to “document.” Some embodiments use a sign/cosine function to generate the positional encoder vector as follows:

$$PE \_ ( ( pos , 2 i ) ) = sin ( pos / 10000 ⋀ ( 2 i / d \_model ) ⊣ )$$

$$PE \_ ( ( pos , 2 i + 1 ) ) = cos ( pos / 10000 ⋀ ( 2 i / d \_model ) ) ⊣$$

After passing the input(s) 301 through the input embedding 302 and applying the positional encoder 304, the output is a word embedding feature vector, which encodes positional information or context based on the positional encoder 304. These word embedding feature vectors are then passed to the encoder and/or decoder block(s) 306, where it goes through a multi-head attention layer 306-1 and a feedforward layer 306-2. The multi-head attention layer 306-1 may be responsible for focusing or processing certain parts of the feature vectors representing specific portions of the input(s) 301 by generating attention vectors. For example, in Question Answering systems, the multi-head attention layer 306-1 determines how relevant the ith word (or particular word in a sentence) is for answering the question or relevant to other words in the same or other blocks, the output of which is an attention vector. For every word, some embodiments generate an attention vector, which captures contextual relationships between other words in the same sentence or other sequence of characters. For a given word, some embodiments compute a weighted average or otherwise aggregate attention vectors of other words that contain the given word (for example, other words in the same line or block) to compute a final attention vector.

In some embodiments, a single headed attention has abstract vectors Q, K, and V that extract different components of a particular word. These are used to compute the attention vectors for every word, using the following formula:

$$Z = softmax ( Q . K ⋀ T / √ ( Dimension of vector Q , K or V ) ) . V$$

For multi-headed attention, there may be multiple weight matrices Wq, Wk and Wv, so there are multiple attention vectors Z for every word. However, a neural network may only expect one attention vector per word. Accordingly, another weighted matrix, Wz, is used to make sure the output is still an attention vector per word. In some embodiments, after the layers 306-1 and 306-2, there is some form of normalization (for example, batch normalization and/or layer normalization) performed to smoothen out the loss surface making it easier to optimize while using larger learning rates.

Layers 306-3 and 306-4 represent residual connection and/or normalization layers where normalization re-centers and re-scales or normalizes the data across the feature dimensions. The feedforward layer 306-2 is a feed forward neural network that is applied to every one of the attention vectors outputted by the multi-head attention layer 306-1. The feedforward layer 306-2 transforms the attention vectors into a form that may be processed by the next encoder block or making a prediction at 308. For example, given that a document includes first natural language sequence “the due date is . . . ” the encoder/decoder block(s) 306 predicts that the next natural language sequence will be a specific date or particular words based on past documents that include language identical or similar to the first natural language sequence.

In some embodiments, the encoder/decoder block(s) 306 includes pre-training to learn language (pre-training) and make corresponding predictions. In some embodiments, the encoder/decoder block(s) 306 learns what language and context for a word is in pre-training by training on two unsupervised tasks—Masked Language Modeling (MLM) and Next Sentence Prediction (NSP)—simultaneously or at the same time. In terms of the inputs and outputs, at pre-training, the natural language corpus of the inputs 301 may be various historical documents, such as text books, journals, web data, and/or periodicals in order to output the predicted natural language characters in 308 (not make the predictions at prompt engineering or prompt tuning at this point). The encoder/decoder block(s) 306 takes in a sentence, paragraph, or sequence (for example, included in the input(s) 301), with random words being replaced with masks. The goal is to output the value or meaning of the masked tokens. For example, if a line reads, “please [MASK] this document promptly,” the prediction for the “mask” value is “send.” This helps the encoder/decoder block(s) 306 understand the bidirectional context in a sentence, paragraph, or line at a document. In the case of NSP, the encoder/decoder block(s) 306 takes, as input, two or more elements, such as sentences, lines, or paragraphs and determines, for example, if a second sentence in a document actually follows (for example, is directly below) a first sentence in the document. This helps the encoder/decoder block(s) 306 understand the context across all the elements of a document, not just within a single element. Using both of these together, the encoder/decoder block(s) 306 derives a good understanding of natural language during pre-training.

In pre-training, the output is typically a binary value C (for NSP) and various word vectors (for MLM). With training, a loss (for example, cross entropy loss) is minimized. In some embodiments, all the feature vectors are of the same size and are generated simultaneously. As such, each word vector may be passed to a fully connected layered output with the same number of neurons equal to the same number of tokens in the vocabulary.

In some embodiments, once pre-training is performed, the encoder/decoder block(s) 306 performs prompt engineering, prompt-tuning, and/or fine tuning. For example, for fine tuning, some embodiments perform a QA task by adding a new question-answering (or prompt-response) head or encoder/decoder block in 306, just the way a masked language model head is added (in pre-training) for performing a MLM task, except that the task is a part of fine-tuning to add new input data in the input(s) 301 and adjust the weights formulated during pre-training. In other words, fine-tuning adds additional input data (i.e., the specific prompts in the input(s) 301 that are not part of pre-training) and performs additional rounds of training to further adjust weights to formulate the output(s) 308 that are not part of pre-training.

Prompt engineering is the process of guiding and shaping ML model responses (e.g., the output(s) 308) by relying on the user, or prompt engineer, to craft more carefully phrased and specific queries or prompts. With prompt engineering, the weights are frozen (i.e., its values remain the same from pre-training) such that they are not adjusted during prompt engineering. A “prompt” as described herein includes one or more of: a natural language request (e.g., a question, command, or instruction (e.g., “write a summary of a poem”)), one or more datasets (e.g., a particular document or image), code snippets, mathematical equations, one or more examples (e.g., one-shot or two-shot examples), and/or a numerical embedding (e.g., a “soft” prompt). In some embodiments, an “example” is indicative of few-shot prompting, which is a technique used to guide large language models (LLMs), like GPT-3, towards generating desired outputs by providing them with a few examples of input-output pairs.

The prompt engineering process often involves iteratively asking increasingly specific and detailed questions/commands/instructions or testing out different ways to phrase questions/commands/instructions. The goal is to use prompts to elicit better behaviors or outputs from the model. Prompt engineers typically experiment with various types of questions/commands/instructions and formats to find the most desirable and relevant model responses. For example, a prompt engineer may initially provide a prompt (i.e., the “event data prompt” of the input(s) 301) from the event data retriever 118 with “what is the weather like” today?”, where the “event data output” in the outputs 308 initially states that “the weather is sunny.” However, this may not be specific enough, so the prompt engineer may formulate another prompt template that states, “what is the temperature now and for the next 4 hours” and the responsive “event data output” is “the temperature is 68 degrees and will remain this temperature for the next three hours, then the temperature will drop to 65 degrees.” The prompt engineer may be satisfied with this prompt. Subsequent to this satisfactory answer, particular embodiments save the corresponding event data prompt as a template (e.g., “what is the temperature now and for the next 4 hours?”). In this way, the prompt template (e.g., a “hard” prompt) may be used at runtime or when the model is deployed. In some embodiments, such template leaves certain words in the prompt template blank because the blank space may depend on the use case provided by the runtime prompt. For example, using the example template above, the template may read, “ . . . for the next ______ hours . . . ”

Prompt tuning is the process of taking or learning the most effective prompts or cues (among a larger pool of prompts) and feeding them to the encoder/decoder block(s) 306 as task-specific context. For example, a common question or phrase—“What is my account balance?”—could be taught to the encoder/decoder block(s) 306 to help optimize the model and guide it toward the most desirable decision or corresponding outputs in 308. Unlike prompt engineering, prompt tuning is not about a user formulating a better question or making a more specific request. Prompt tuning means identifying more frequent or important prompts (e.g., which have higher node activation weight values) and training the encoder/decoder block(s) 306 to respond to those common prompts more effectively. The benefit of prompt tuning is that it may be used to modestly train models without adding any more input(s) 301 or prompts (unlike fine-tuning), resulting in considerable time and cost savings.

In some embodiments, prompt tuning may use soft prompts only, and may not include the use of hard prompts. Hard prompts are manually handcrafted text prompts (e.g., prompt templates) with discrete input tokens, which are typically used in prompt engineering. Prompt templating allows for prompts to be stored, re-used, shared, and programmed. Soft prompts are typically created during the process of prompt tuning. Unlike hard prompts, soft prompts are typically not viewed and edited in text. Soft prompts typically includes an embedding, a string of numbers, that derives knowledge from the encoder/decoder block(s) 306 (e.g., via pre-training). Soft prompts are thus learnable tensors concatenated with the input embeddings that may be optimized for a dataset. In some embodiments, prompt tuning creates a smaller light weight model which sits in front of the frozen pre-trained model (i.e., the large language model 300 with weights set during pre-training). Therefore, prompt tuning involves using a small trainable model before using the LLM 300. The small model is used to encode the text prompt and generate task-specific virtual tokens. These virtual tokens are pre-appended to the prompt and passed to the LLM 300. When the tuning process is complete, these virtual tokens are stored in a lookup table (or other data structure) and used during inference, replacing the smaller model.

As illustrated in FIG. 3, there are specific prompts of the input(s) 301 and the output(s) 308, which are described as follows. In some embodiments, the prompts of the input(s) 301 represent final prompt-tuned, fine-tuned, and/or prompt engineered prompts. The “natural language extractor prompt” is a prompt (or portion of a prompt) that is generated by the prompt construction block(s) 130 based on the output of the natural language extractor 108 of FIG. 1. For example, in some embodiments, the natural language extractor prompt may include one or more of the following: a query (e.g., “what traffic sign is this”?), an instruction (e.g., “tell the driver what the traffic sign says”), a zero-shot, 1-shot, or few-shot example of one or more representative inputs (e.g., a natural language description of a stop sign generated via a CLIP model), outputs (e.g., “this is a stop sign”), entity data (e.g., determined via NER) associated with the one or more extracted natural language characters, and/or a hierarchical data structure (e.g., a waterfall data structure) representing multiple features of an environment that an ego-machine is in and their spatial relationships (e.g., specific map of a driving environment and their features). Responsively, the model generates one or more of the outputs in 308, such as the “natural language extraction output,” such as “you just passed a stop sign.”

The “event data prompt” of the input(s) 301 is a prompt (or portion of a prompt) that is generated by the prompt construction block(s) 130 based on the output of the event data retriever 118 of FIG. 1. For example, the event data prompt may include weather data for an area that the ego machine is in, traffic data of the area, a radio station feed of the area, an indication of a particular sporting event in the area, an instruction (e.g., “tell the driver the specific temperature and whether there are any accidents within the next 3 miles”), a zero-shot, one-shot or few-shot example, and/or the like. Responsively, the encoder/decoder block(s) 306 provides one or more of the output(s) 308, such as the “event data output.” For example, the “event data output” may be a text summarization of the weather data, the traffic data, the radio station feed, the sporting event, or the like.

The “object context prompt” of the input(s) 301 is a prompt (or portion of a prompt) that is generated by the prompt construction block(s) 130 based on the output of the object context generator 120 of FIG. 1. For example, the object context prompt may include parking context, such as a time of day that elements representing a parking sign was detected, a day of week that the elements representing the parking sign was detected, an ego-machine type, an instruction (e.g., “tell the driver whether the parking spot is available,”) and/or an indication of whether an object detector detected a car in the parking spot. Responsively, the encoder/decoder block(s) 306 generate an output in 308, such as parking spot availability. For example, such output may be a natural language sentence that reads, “this parking spot is not available for parking because the parking instructions in the sign state that the spot is available after 7 p.m. but it is not yet 7 p.m.”

The “operator view prompt” of the input(s) 301 is a prompt (or portion of a prompt) that is generated by the prompt construction block(s) 130 based on the output of the operator view probability component 128/228 of FIG. 1/FIG. 2. For example, the operator view prompt may include an indication of the hierarchical data structure as described above (e.g., the “waterfall” structure), a representation of a score representing a probability that an operator did not see an object, an instruction (e.g., “tell the driver whether they missed the traffic sign”), and/or a zero-shot, one-shot, or few-shot example of an input and/or output. Responsively, as at least a portion of the output(s) 308, the encoder/decoder block(s) 306 may generate a natural language response representing the “operator view response” such as “it appears that you missed the stop sign.”

The “description/travel route prompt” of the input(s) 301 is a prompt (or portion of a prompt) that is generated by the prompt construction block(s) 130 based on the output of the destination/travel route information extractor 122 of FIG. 1. For example, this prompt may include all the destination and/or travel route information extracted from the destination/travel route data 124, an instruction to “summarize the destination and/or travel route information,” and/or a zero-shot, one-shot or few shot example. Responsively, the encoder/decoder block(s) 306 generate, in the output(s) 308, the “summarized information about the destination/travel route.” For example, the destination/travel route data 124 may include all the tourist areas along the travel route and various pieces of information about each tourist area. The summary may include a high-level synopsis of each tourist area without all the information about each tourist area. For example, such summary may be, “during your travel route, you will first visit Phoenix, Payson, and then you will arrive at the Grand Canyon. The Grand Canyon closes around 6 p.m. today.”

The “operator alertness level prompt” of the input(s) 301 is a prompt (or portion of a prompt) that is generated by the prompt construction block(s) 130 based on the output of the operator alertness level detector 206 of FIG. 2. For example, such prompt may include the personalized information 212, a representation of the computed alertness level of the operator (e.g., “the operator is extremely sleepy”), a natural language instruction, such as “start a conversation with the driver that aligns with the driver's interests (e.g., American football),” a zero-shot, one-shot or few shot examples of representative inputs/outputs, and/or “send a control signal to honk the horn.” One or more of these inputs prompt the encoder/decoder block(s) 306 to output, at the output(s) 308, the “response to operator alertness level.” For example, such response may be “I've just honked the horn because you are falling asleep. Do you know the name of the only quarterback to win a regular season MVP, a Super Bowl, and a Super Bowl MVP all in one season?”

The “operator response prompt” of the input(s) 301 is a prompt (or portion of a prompt) that is generated by the prompt construction block(s) 130 based on the output of the operator response handler 208 of FIG. 2. For example, such prompt may include the natural language utterance that an operator issued (e.g., the answer to the Super Bowl question above, such as “Patrick Mahomes”), a new or second representation of another alertness level detected (e.g., “the driver is now more awake and is at a KSS value of 4”), an instruction (e.g., “respond back to the driver based on his new KSS value”), a zero-shot, one-shot, or few shot example, and/or the like. Responsive to the encoder/decoder block(s) 306 ingesting such prompt, it produces, in the output(s) 308, the “response to operator response.” For example, such response may be “your answer of Patrick Mahomes is correct. I'm glad you're more alert. Should I call a nearby hotel so you can sleep?”

The “personalized information” of the input(s) 301 is a prompt (or portion of a prompt) that is generated by the prompt construction block(s) 130 based on the output of the personalized information extractor 210 of FIG. 2. For example, such prompt may include all the personalized information 212, an instruction (e.g., “use the personalized information to start a conversation with the driver”), a hierarchical data structure as described herein, and/or a zero-shot, few-shot or one-shot example. Responsively, the encoder/decoder block(s) 306, generates, at the output(s) 308, a response. For example, if the personalized information 212 indicates that the driver enjoys bass fishing and the driver is near a particular lake that is known for bass fishing (e.g., as determined via the hierarchical data structure and the event data 114), the model may generate a natural language response, such as “there is a lake—Lake Murray—that is about 5 miles ahead. This lake is known for being one of the best bass fishing lakes in the country.”

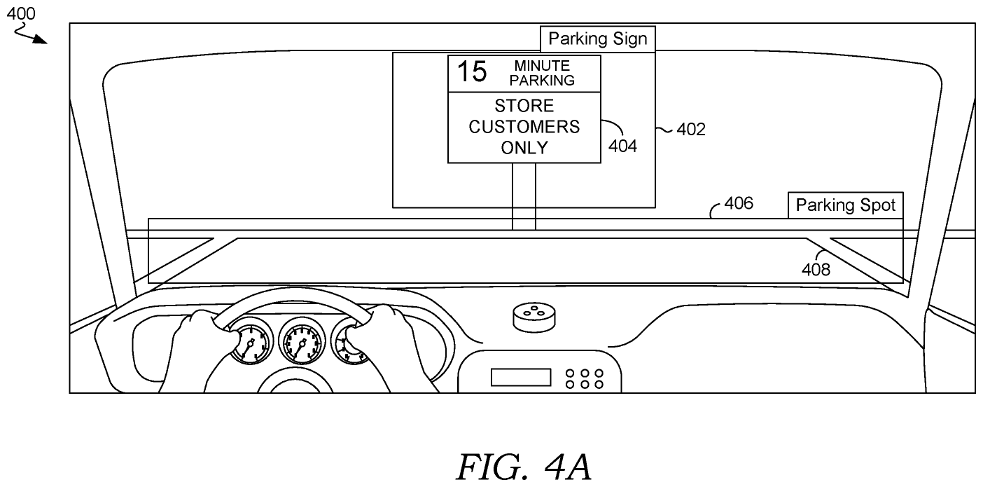

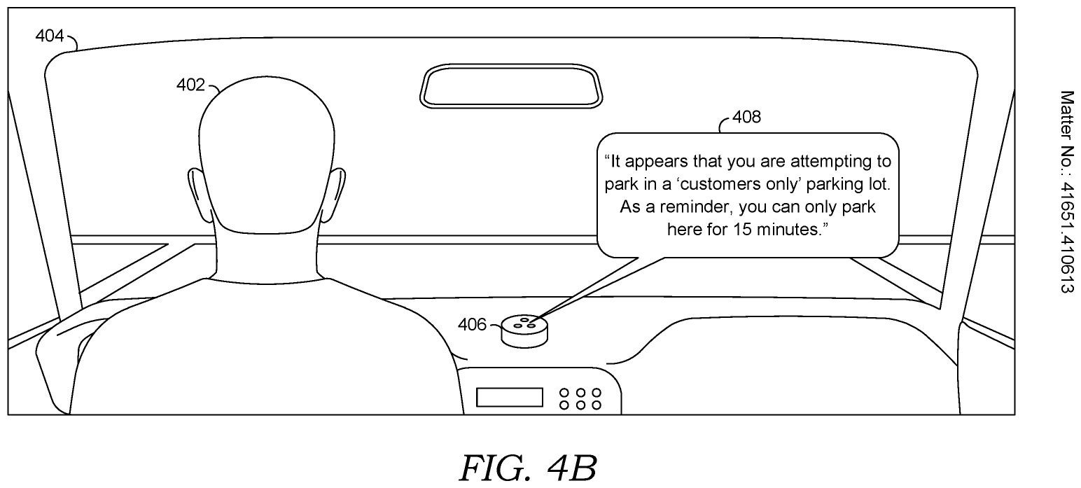

FIG. 4A illustrates image data 400 of a parking sign 404 and a parking spot 408, according to some embodiments. In some embodiments, the image data 400 is determined or detected by the exterior perception camera(s) 102 and/or the object detector 106 as described with respect to FIG. 1. The image data 400 (e.g., various pixels) includes a bounding box 402 (labelled as “parking sign”) that is disposed over a subset of the image data 400 representing the parking sign 404. The image data 400 also includes a bounding box 406 (labeled “parking spot”) that is disposed over a subset of the image data 400 representing the parking spot 408.

In some embodiments, the object detector 106 detects the parking sign 404, as illustrated by the bounding box 402 and detects the parking spot 408 (and that no car is taking the parking spot 408), as illustrated by the bounding box 406. Responsive to such detection, in some embodiments, the natural language extractor 108 responsively extracts the natural language text within the parking sign 404, as described with respect to FIG. 1. For example, the natural language extractor 108 may perform OCR functionality to encode the image data in 404 (i.e., “15 minute parking STORE CUSTOMERS ONLY”) into a JSON data structure, where the resulting JSON natural language characters are fed, as at least a portion of the “natural language extractor prompt” in 301 into the encoder/decoder block(s) 306 as input. Additionally or alternatively, the object context generator 120 provides the “object context prompt” as indicated in the input(s) 301 as input. For example, the object context prompt may include an indication that “nobody is occupying the parking spot” (e.g., as detected by the object detector 106). Responsively, the model generates, as a natural language response, an output, such as the natural language response 414 of FIG. 4B, as described in more detail below.

FIG. 4B illustrates a natural language response 414 to the natural language characters being extracted from the traffic sign 404 of FIG. 4A and/or the parking spot 408 of FIG. 4A being detected, according to some embodiments. That is, for example, the natural language response generator 230 generates a response “it appears that you are attempting to park in a ‘customers only’ parking lot. As a reminder, you may only park here for 15 minutes.” Such response may be based on the model having been prompt engineered, prompt-tuned, and/or fine-tuned to generate this response based on performing natural language processing and otherwise extracting the natural language characters from the parking sign 404 and/or ingesting a prompt that indicates that the parking spot 408 is available. If the parking spot was not available (e.g. because a car was parked in the parking spot 408 or because of special instructions within the parking sign 404), the model may additionally or alternatively tell the driver 410 that they may not park there.

Responsive to the natural language response generator 132 generating such output, it returns the output to the text-to-speech component 131, which then outputs, as audio data and at the sound device 416, the audio message 414—“It appears that you are attempting to park in a ‘customers only’ parking lot. As a reminder, you may only park here for 15 minutes.”

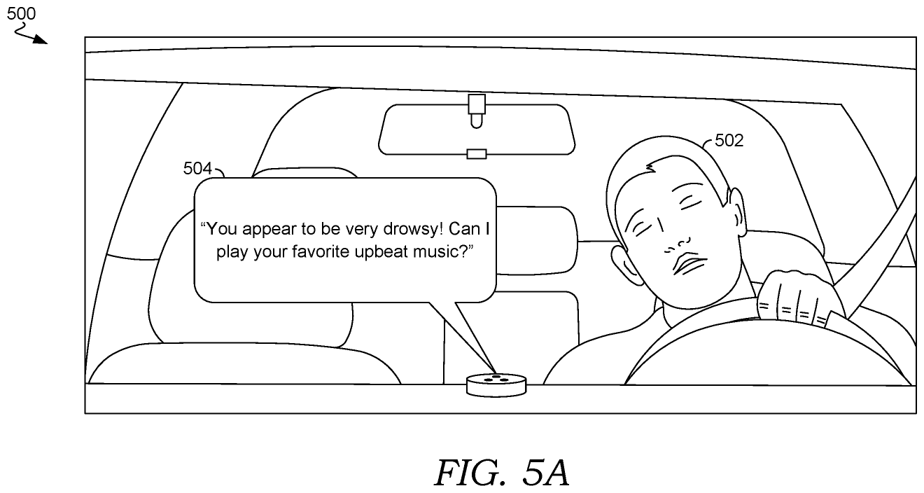

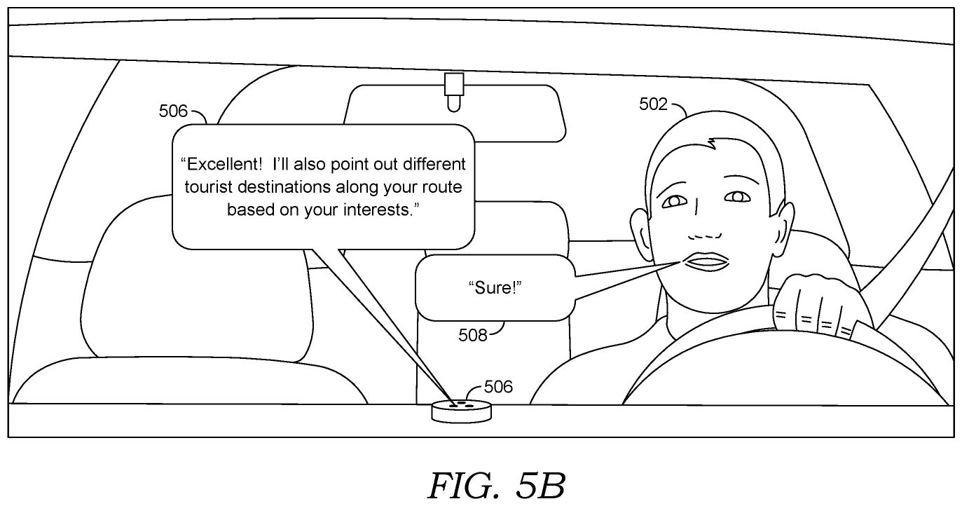

FIG. 5A illustrates an ego-machine operator 502 (or image data of the operator 502) in a drowsy state and a responsive natural language response 504, according to some embodiments. In some embodiments, one or more portions of the operator 502 or corresponding image data are analyzed by the operator alertness level detector 206, as described with respect to FIG. 2. For example, a DMS camera in a steering column of a vehicle may employ an eye tracking module that sends out an infrared light that is supposed be reflected in the operator 502's eyes. However, the operator 502's eyes may be shut or not looking straight ahead. Responsively, a CNN or other model may classify the operator 502 with a confidence level score or prediction that the driver is drowsy. Responsively, particular embodiments map, via a lookup data structure, such score to a KNN level natural language output, such as “the operator has a KSS level score of 8, which is sleepy but some effort to alert.”

Responsively, the operator alertness level detector 206 sends such natural language phrase to the language model(s) 226, at which the prompt construction block(s) 226 generate the “operator alertness level prompt” of the input(s) 301, which includes the KSS level score natural language phrase. Responsively, the natural language response generator 132 generates a natural language response, such as “You appear to be very drowsy! May I play your favorite upbeat music?” Responsively, the natural language response generator 132 automatically transmits such response to the text-to-speech component 134, which converts such natural language response to the audio data response 504, such that the audio device 506 (e.g., a car speaker) outputs the audio data response 504 in the form of sound waves, which mirrors the response generated by the natural language response generator 232.

In various embodiments, audio data response 504 or other generated response to a computed alertness level described herein is indicative of initiating personalized conversations with an operator based on KSS levels with the intention of reducing KSS or other non-attentiveness level of an operator to some threshold. For instance, some embodiments keep generating, in a loop, natural language sentences indicative of conversing with an operator until a KSS level or threshold is met (e.g., a KSS level of 4). In some embodiments, this may be used to further refine the topics (e.g., personalized topics) that actually help reduce KSS level versus those that do not. For example, reinforcement learning may be used to learn that any discussion of topic A is likely to cause a reduction in KSS levels relative to topic B for a particular operator based on a history of different topics discussed with the operator in the past. Accordingly, instead of using topic B in a conversation with an operator, a language model may only discuss topic A based on model rewards given in reinforcement training for generating natural language responses where topic A was discussed (and/or penalties for generating natural language responses where topic B was discussed).

FIG. 5B illustrates the operator 502 of FIG. 5A's response 508 to the audio response 504 of FIG. 5A and a model's response 510 to the operator 502's response 508, according to some embodiments. Accordingly, subsequent to the audio device 506 outputting the audio response 504, the operator 502 (whose eyes may now be opened and who is more alert) may say issue the audio response 508, which is “sure.” Responsively, the operator response handler 208 may take such “sure” response, perform speech-to-text functionality on such audio response 508, and then send the corresponding natural language response/text (no longer audio data) to the language model(s) 226 as input. Responsively, the prompt construction block(s) 230 generates the “operator response prompt” as indicated in the input(s) 301 of FIG. 3, which includes the text-based “sure” (representing 508) word.

Additionally or alternatively, the operator alertness level detector 206 detects, again at a second time, the alertness level of the operator 502 as is illustrated in FIG. 5B. For example, using the DMS, the operator alertness level detector 206 may detect that the KSS level is now 4 “rather alert” (e.g., somewhat alert), which means that the driver 502 is now more alert relative to the state of the driver 502 in FIG. 5A. Such new KSS level 4 may also be provided to the language model(s) 226 as input. Responsively, the natural language response generator 232 generates a natural language response “Excellent! I'll also point out different tourist destinations along your route based on your interests.” Such natural language response may also be based on ingesting the personalized information 212 as an input (or partial input) from the personalized information extractor 210 (e.g., included in the “personalized information prompt” of input(s) 301) and/or the destination/travel route data 124 from the destination/travel route information extractor 122 (e.g., included in the “destination/travel route prompt” of the input(s) 301). Responsively, the natural language response generator 132 transmits such natural language response to the text-to-speech component 134, which converts, via the audio device 506, such response to the corresponding audio response 510. Responsively, in some embodiments, the personalized information extractor 210 searches in the personalized information 212 and/or contacts a music service to retrieve the operator 502's favorite upbeat music and/or user's interests with respect to tourist destinations (e.g., the operator may like the Grand Canyon). When such music and/or other interests are retrieved, the audio device 506 may then automatically play audio data representing the operator 502's favorite upbeat music. Additionally or alternatively the destination/travel route information extractor 122 and/or the personalized information extractor 210 may provide input travel route/destination and/or personalized information so that the operator 502 is notified of different tourist destinations along a route based on interests (e.g., notifying operator 502 that the next tourist area on his route is the Grand Canyon, which he is interested in).

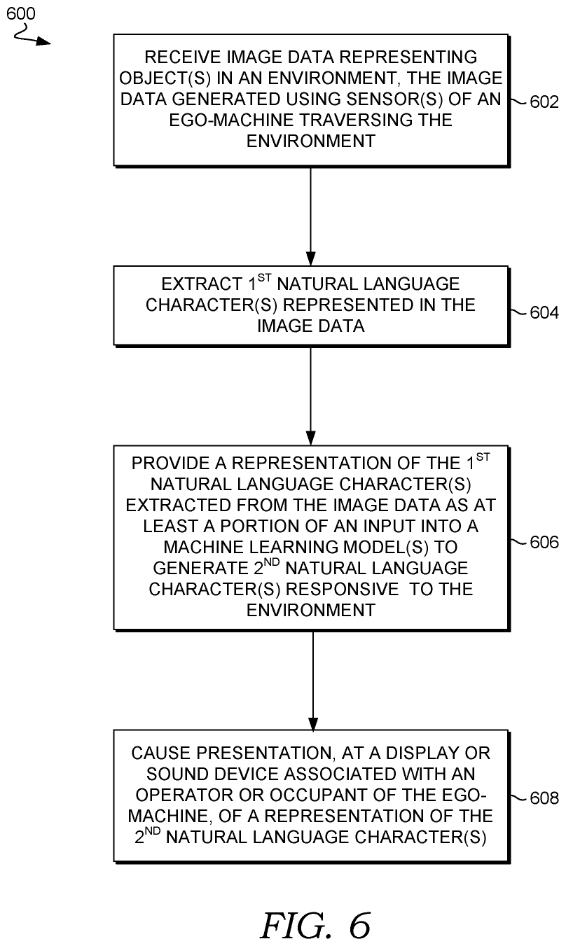

Now referring to FIGS. 6, 7, 8, and 9, each block of processes 600, 700, 800, and 900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 600, 700, 800, and 900 are described, by way of example, with respect to the pipeline 100 of FIG. 1 and/or pipeline 200 of FIG. 2. However, these methods may additionally or alternatively be executed by any one system, or any combination of systems, including, but not limited to, those described herein.

FIG. 6 is a flow diagram of an example process 600 for generating a natural language response based on extracting natural language character(s) represented in image data, according to some embodiments. Per block 602, some embodiments receive image data representing one or more objects in an environment, where the image data is generated using one or more sensors (e.g., cameras) of an ego-machine (e.g., a car, a watercraft, or aircraft). For example, referring back to FIG. 1, after a camera mounted on a vehicle has captured image data of a driving environment that includes street signs, streets, traffic lights or other physical structures, and such data has been stored, the object detector 106 may receive such data.

Per block 604, particular embodiments extract first one or more natural language characters represented in the image data. In some embodiments, “extracting” in this context means to identify and/or capturing natural language character(s) in the image data and convert the image data natural language characters into machine-readable and editable text that is no longer in an image data format. For example, converting may include using pattern recognition and machine learning algorithms to encode the image data natural language characters into a data structure that includes a JSON string of matching natural language characters. The “first one or more natural language characters” thus represent the output encoded characters (or non-image data) represented in the image data.

In an illustrative example of block 604, in some embodiments, the one or more objects include a traffic sign. Accordingly, for example, particular embodiments detect, via object detection (e.g., via the object detector 106) and within the image data, one or more regions of the image data depicting the traffic sign (e.g., via the bounding box 402). Some embodiments extract the one or more first natural language characters represented in the traffic sign based at least on performing optical character recognition (OCR) within the one or more regions of the image data in response to detecting the one or more regions of the image date depicting the traffic sign. For example, this is described in FIG. 1, where the natural language extractor 108 may extract natural language characters from one or more objects in response to the object detector 106 detecting one or more objects.

Additionally or alternatively, some embodiments determine that a speed of the ego-machine is below or exceeds a threshold speed. Accordingly, the extraction of the one or more first natural language characters represented in the traffic sign occurs at least partially responsive to the determining that the speed of the ego-machine is below or exceeds the threshold speed. For example, referring back to FIG. 1, the natural language extractor 108 may extract natural language characters responsive to determining whether the speed detected from the speed detection component 110 is below or exceeds the threshold.

Per block 606, some embodiments provide a representation (e.g., a hard prompt or soft prompt) of the first one or more natural language characters extracted from the image data as at least a portion of the an input into one or more machine learning models to generated second one or more natural language characters responsive to the environment. In some embodiments, “providing” the representation includes transmitting (e.g., across a network and to another compute node) the representation to a device that includes the machine learning model(s). Providing may alternatively or additionally include programmatically returning or passing the representation to the machine learning model(s) (e.g., which is stored to the same compute node). In some embodiments, block 606 alternatively generates the second one or more natural language characters based on providing the representation of the first one or more natural language characters extracted from the image data as at least a portion of an input into a machine learning model(s). In some embodiments, “responsive to the environment” means based on, according to, or otherwise associated with the environment. In other words, the model outputs natural language characters that are in some way related to the environment that the ego-machine has traversed.

In some embodiments, the generation of the second one or more natural language characters at block 606 is based on additional or alternative inputs and/or portions of the input (e.g., additional prompts), as described herein. For example, in some embodiments, the input at block 606 includes a prompt and that one or more machine learning models includes a Large Language Model (LLM). In some embodiments, such prompt further includes a query (e.g., “tell the driver what sign they passed and what the sign said”) and one or more of: a zero-shot, 1-shot or few-shot examples of one or more representative inputs and/or outputs (e.g., “you just passed a stop sign”), entity data associated with the one or more first natural language characters (e.g., NER entities of the characters), or a hierarchical data structure (e.g., a waterfall structure) representing multiple features (e.g., connecting roads, orientation of traffic lights and signs) of the environment. For instance, such data may be included in the “natural language extractor prompt” indicated in the input(s) 301 of FIG. 3. In this way, the generation of the second natural language character(s) is based on the LLM ingesting the prompt. For instance, the second natural language character(s) may be, “you may want to slow down, you just missed a stop sign.” (e.g., as detected by the object detector 106 and/or the speed detection component 110).

Continuing with block 606, in some embodiments, the one or more objects represent a traffic sign (e.g., a yield sign, a stop sign, a traffic light, a deer sign, etc.). In some embodiments, the traffic sign is a parking sign that includes parking instructions. Parking instructions indicate how or when parking is available, as illustrated, for example, in the parking sign 404 of FIG. 4A. In these embodiments, various embodiments provide a representation of parking context (e.g., metadata) as at least a second portion of the input into the machine learning model(s). In some embodiments, the parking context includes at least one of: a time of day that the elements representing the parking sign was detected (e.g., as performed by the object detector 106), a day of week that the elements representing the parking sign was detected (e.g., as performed by the object detector 106), an ego-machine type (e.g., a make and model) of the ego machine, or an indication of whether a parking spot is available for parking. For example, all of this information may be provided by the object context generator 120 and or be represented in the “object context prompt” as illustrated in the input(s) 310. In this way, particular embodiments output a particular natural language phrase (representing the second one or more natural language characters) indicating a prediction of whether the parking spot is permitted to be occupied by the ego-machine based at least on the parking context and the parking instructions. For instance, if the time of day indicated in this prompt falls outside of a time of day window (e.g., “only park between 6 and 8”), this may be used to inform the operator that they may not park in the corresponding parking spot.

Continuing with block 606, some embodiments receive a geo-location indicator that represent a location of the ego-machine in the environment. Based at least on the geo-location indicator, particular embodiments (e.g., the event data retriever 118) determine at least one of: weather data, road condition data, traffic data, or event data associated with the geo-location (e.g., as stored to the event data 114). Responsively, particular embodiments provide at least one of the weather data, the road condition data, the traffic data, the event data, or the geo-location indicator as at least a second portion of the input into the one or more machine learning models. For example, such event data may include or represent the “event data prompt” in the input(s) 301 in order to generate the “event data output” as indicated in the output(s) 308.

Continuing with block 606, some embodiments receive, at a first time, second image data representing one or more portions of the operator of the ego-machine. Based at least on the second image data, some embodiments generate a first score (e.g., a KSS score) representing a first alertness level of the operator. An indicator or representation of the first score is provided as at least a second portion of the input into the machine learning model(s). For example, such second portion may represent or include the “operator alertness level prompt” as indicated in the input(s) 301 in order to produce the “response to operator alertness level” in the output(s) 308.

Continuing with block 606, some embodiments provide a representation of a computed alertness level of the operator and/or a phrase utterance that represents an operator response (e.g., the “sure” response 508 of FIG. 5B) by the operator to the presented representation of the one or more second natural language characters (e.g., the audio output 504 of FIG. 5A), as a subsequent input into the one or more machine learning models to generate one or more third natural language characters (e.g., the audio output 510 of FIG. 5B) representing a generated response to the operator response. For example, this subsequent input may include or represent a second “operator alertness level prompt” and/or the “operator response prompt” in the input(s) 301 in order to generate the “response to the alertness level” and/or the “response to the operator response” as indicated in the output(s) 308.

Continuing with block 606, some embodiments provide a representation of personalized information associated with the operator retrieved from a database (e.g., the personalized information 212) as at least a second portion of the input into the machine learning model(s). For example, such second portion may represent or include the “personalized information prompt” as indicated in the input(s) 301 in order to generate the “response to operator alertness level” and/or the “response to operator response” as indicated in the output(s) 308.

Continuing with block 606, in some embodiments the object(s) include a traffic sign. Some embodiments receive a score representing a probability that the operator did not see (or did see) the traffic sign based at least in the first image data and the second image data representing one or more portions of the operator or occupant. For example, as described herein some embodiments use a waterfall or other hierarchical data structure to compare the near real-time data (e.g., GPS location) of where the ego-machine is and various objects in the environment (e.g., a STOP sign) versus DMS data (e.g., eye gaze) indicating whether the operator saw the stop sign. Responsively the score (e.g., a binary classification Boolean or binary “YES”) is produced and then mapped (e.g., via a hand-coded data structure) to a natural language sequence, such as “the operator did see the traffic sign”. Such representation of the score is then provided as at least a second portion of the input into the machine learning model(s). For instance, in some embodiments, such representation includes or represents the “operator view prompt” in the input(s) 301 to produce the “operator view prompt,” as indicated in the output(s) 308.

Continuing with block 606, based at least on a geo-location indicator, some embodiments access first audio data (e.g., in the event data 114) associated with a radio station. The geo-location indicator represent a location of the ego-machine in the environment. Various embodiments then provide a representation of the audio data as at least a second portion of the input into the one or more machine learning models, where the one or more second natural language characters include or represent a summary of the representation of the audio data. For example, such second portion may include the “event data prompt” of the input(s) 301 in order to produce the “event data output” as indicated in the output(s) 308 of FIG. 3.

Continuing with block 606, some embodiments access, from one or more data sources (e.g., the destination/travel route data 124), destination or travel route information associated with a destination or travel route of the ego-machine. Some embodiments then provide a representation of the destination or travel route information as at least a second portion of the input into the machine learning model(s) to generate a summarized representation of the destination or travel route information. For example, such second portion may include or represent the “destination/travel route prompt” of the input(s) 301 in order to produce the “summarized information about destination/travel route” of the output(s) 308.

Per block 608, some embodiments cause presentation, at a display (e.g., an LCD screen or monitor) or sound device (e.g., a virtual assistant speaker or car speaker) of a representation of the second natural language characters. For example, such “representation” may represent what is produced by the text-to-speech component 134 and/or the display component 136 of FIG. 1. In another example, such representation may be the audio outputs 414 of FIG. 4A, 504 of FIG. 5A, and/or the 510 of FIG. 5B. According to various embodiments, such representation may reflect any of the embodiments described herein with respect to block 606. For example, a presentation of the representation of the one or more second natural language characters may include a natural language phrase indicating a prediction of whether the parking spot is permitted to be occupied by the ego-machine based at least on the parking context and the parking instructions. In another example, the representation of the second natural language character(s) includes a natural language phrase representing the weather data, the road condition data, the traffic data, and/or the event data. In another example, such representation may include audio data representing a first phrase utterance that initiates a conversation with the operator (e.g., 504 of FIG. 5A) based at least on the first score (alertness level). In another example, the representation may include a first phrase utterance (e.g., audio data 504) that initiates a conversation with the operator based on the personalized information associated with the operator. In another example, the representation may include a phrase that represent a response to the operator or occupant not seeing the traffic sign.

In some embodiments, the process 600 is performed by one or more processing units that comprise at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources, as described with respect to FIGS. 10A through 12.

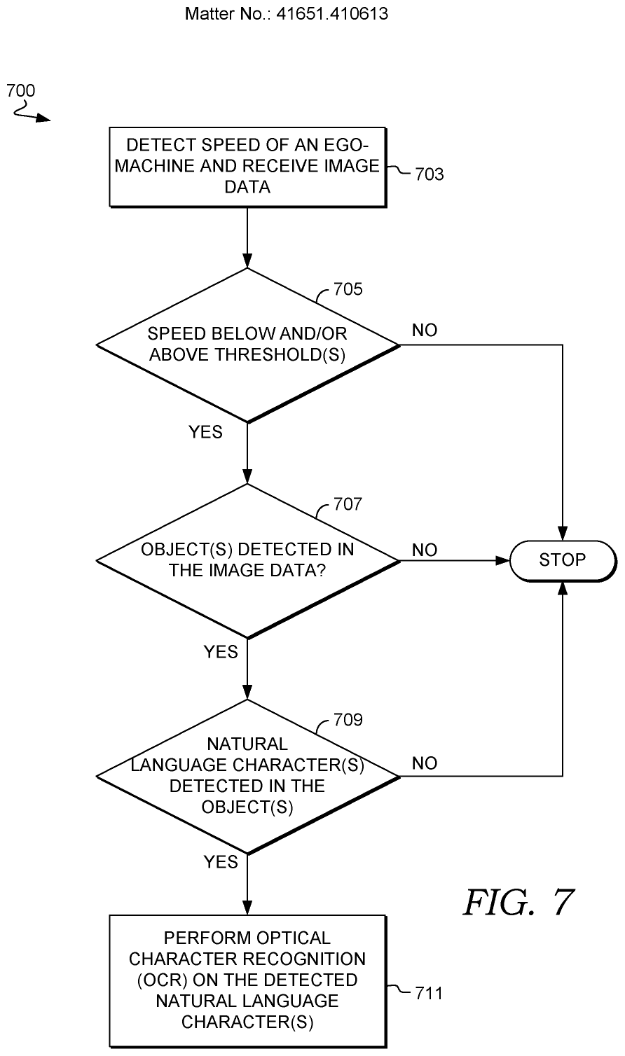

FIG. 7 is a flow diagram of an example process 700 for extracting natural language characters from one or more objects, according to some embodiments. In some embodiments, the process 700 is performed by the natural language extractor 108, the speed detection component 110, and/or the object detector 106 of FIG. 1. Per block 703, some embodiments detect a speed of an ego-machine and receive image data. For example, referring back to FIG. 1, the speed detection component 110 may detect that the speed of an ego-machine is going a particular speed, such as 35 miles-per-hour). Additionally, the object detector 106 may receive image data from the environment image data 104.

Per block 705, some embodiments (e.g., the natural language extractor 108) determine whether such speed is below and/or above one or more thresholds. For example, using the illustration above, it is determined whether 35 MPH is above a 10 MPH threshold. If the decision is “no,” (e.g., the speed is 10 MPH or lower) then the process 700 stops. In another example, it may additionally (or alternatively) be determined whether 35 MPH is above another threshold-a 60 MPH threshold. Accordingly, if it is detected that the speed of the ego-machine is not below the 60 MPH threshold (e.g., it is above 60 MPH; decision “no”), then the process 700 stops. It is understood that in some embodiments, the “no” and “yes” decisions at block 705 are switched around. For example, upon a “yes” decision at block 705 (e.g., the speed is detected to be above a threshold), the process 700 stops.

Continuing with the process 700 at block 707, if the speed is below and/or above one or more thresholds, then particular embodiments (e.g., the natural language extractor 108) perform block 707 by determining whether one or more objects have been detected in the image data. For example, the natural language extractor 108 may receive image data with a bounding box in the image data and/or a binary or Boolean value (e.g., “TRUE” or yes) from the object detector 106 indicating that a traffic sign or other object has been detected. If the decision is “no,” then the process 700 stops.

If one or more objects have been detected (a “yes” decision) then particular embodiments (e.g., the natural language extractor 108) perform block 709 by determining whether one or more natural language characters have been detected in the object(s). For example, in some embodiments, the object detector 106 may include computer vision functionality to check to see whether there are any natural language characters by performing text detection. “Text detection” is the process of identifying regions within image data where text is present. Various techniques, such as the sliding window approach or deep learning-based methods like convolutional neural networks (CNNs), may be used for text detection, for example. These techniques analyze the image and produce bounding boxes around text regions. For example, referring back to FIG. 4A an additional bounding box (not shown) may be generated over the natural language indicia—“15 minute parking STORE CUSTOMERS ONLY.” Responsively, the object detector 106 may pass an indication (e.g., a Boolean value or image data with bounding boxes) that there are natural language characters present in the detected object. If there are not natural language character(s) detected in the detected object(s), then the process 700 stops.

If there are one or more natural language characters detected in the detected object(s), then particular embodiments (e.g., the natural language extractor 108) performs block 711 by performing optical character recognition (OCR) on the detected natural language character(s).

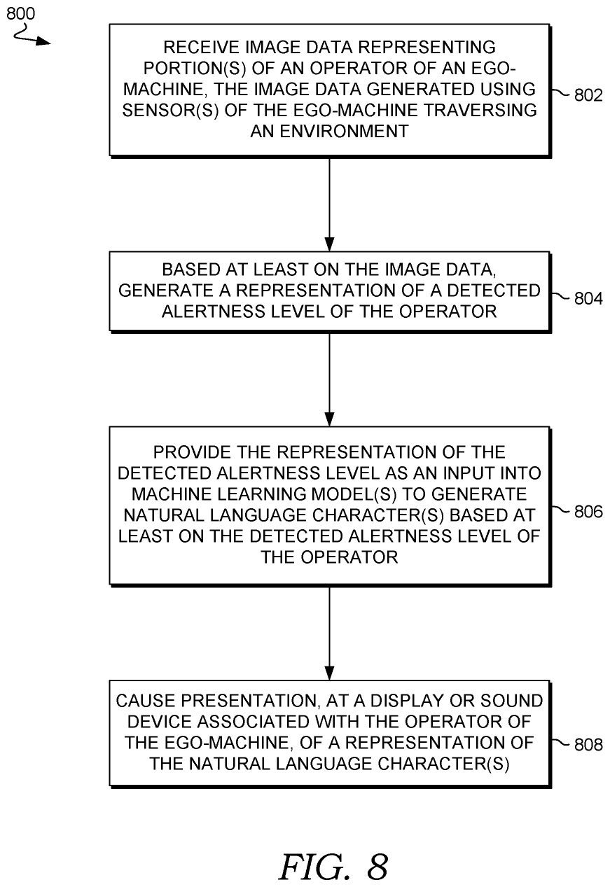

FIG. 8 is a flow diagram of an example process 800 for generating a natural language response based on a computed alertness level of an operator of an ego-machine, according to some embodiments. Per block 802, some embodiments receive image data representing portion(s) of an operator of an ego-machine, where the image data is generated using sensor(s) of the ego-machine traversing an environment. For example, referring back to FIG. 2, the operator alertness level detector 206 may receive image data from the operator image data 204, as described with respect to FIG. 2.

Per block 804, based at least in on the image data, particular embodiments generate a representation (e.g., a direct KSS drowsiness number or score or a natural language sentence indicating the number or score) of a computed alertness level of the operator. For example, referring back to FIG. 2, the operator alertness level detector 296 may be included in a DMS that detects eye gaze, hands dropping, head nodding, and/or the like in the image data, where a CNN has been trained to make a particular classification prediction (e.g., 95 probability that the operator has a KSS sleepiness score of 4). Responsively, such classification score is mapped, via a lookup table, to a natural language sentence (e.g., the representation) that states, “the user has an alertness level of 4.”

Per block 806, particular embodiments provide the representation of the computed alertness level as an input into one or more machine learning models to generate one or more natural language characters based at least on the computed alertness level of the operator. For example, the representation of the computed alertness level may represent or be included in the “operator alertness level prompt” indicated in the input(s) 301 (e.g., an instruction to “ask the user if they want to listen to their favorite music and tell them their alertness level” and an input that the operator's KSS level is 4) in order to generate the “response to operator alertness level” output in the output(s) 308. In some embodiments, additional or alternative inputs (or portions of the input) may be provided into the machine learning model(s). For example, any of the inputs as described with respect to block 606 of FIG. 6 or any of the input(s) 301 of FIG. 3 may be provided. Likewise, any suitable natural language characters may be generated, such as any output in the output(s) 308 of FIG. 3.

Per block 808, some embodiments cause presentation, at a display or sound device, associated with the operator of the ego-machine, of a representation of the natural language characters. For example, block 808 may include causing presentation, at the sound device 506, the audio data 504 and/or 510 of FIG. 5A or FIG. 5B. In some embodiments, the process 800 is performed by one or more processing units that comprise at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources, as described with respect to FIGS. 10A through 12.

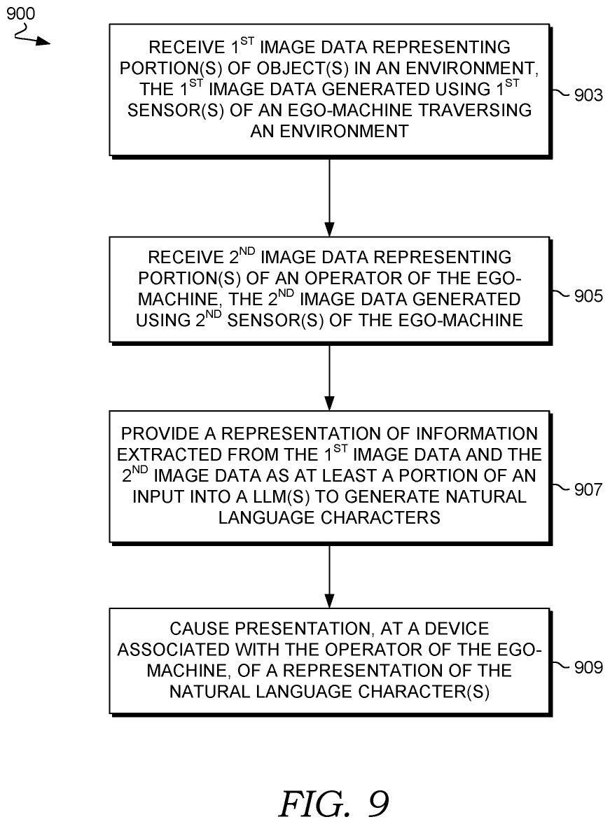

FIG. 9 is a flow diagram of an example process 900 for generating natural language characters based on providing a LLM different sets of image data, according to some embodiments. Per block 903, some embodiments receive first image data representing one or more portions of one or more objects in an environment, where the first image data is generated using one or more first sensors (e.g., an object detection camera) of an ego-machine traversing an environment (e.g. driving down a street). For example, referring back to FIG. 1, the object detector 106 may receive the environment image data 104.

Per block 905, some embodiments receive second image data representing one or more portions of an operator (e.g., a driver) of the ego-machine, where the second image data is generated using one or more second sensors (e.g., a DMS infrared sensor that may be used to monitor the operator's eye movements and track gaze pattern) of the ego-machine. For example, referring back to FIG. 2, the operator alertness level detector 205 may receive the operator image data 204.

Per block 907, some embodiments provide a representation of information extracted from the first image data and the second image data as at least a portion of an input into a LLM to generate one or more natural language characters. For example, the representation of information extracted from the first image data may be objects detected by the object detector 106 and/or natural language characters extracted by the natural language extractor 108. In an example of the representation of the second image data, this may mean a representation of a computed alertness level and/or the operator image data 204 itself, for example. For instance the representation of the operator image data 204 may represent the output of a CLIP model, where the CLIP model describes, in natural language, each feature of the second image data (e.g., “this is a picture with the driver's eyes being close and his head dropping while hands are on the wheel”). In some embodiments, the output of CLIP model is alternatively or additionally the representation of the information extracted from the first image data. For example, based on object detection functionality of a stop sign, a CLIP model may be used to generate a natural language output stating, “this image data illustrates a red stop sign.” Accordingly, such natural language output (or soft prompt representing such output) may be directly provided to the LLM to produce an output.

In some embodiments the representations at block 907 include or represent the “natural language extractor prompt” and the “operator alertness level prompt” in the input(s) 301 of FIG. 3. In some embodiments, the LLM generates the natural language character(s) at block 907 based on additional or alternative inputs (or portions of the input). For example, other portions of the input may include any of the prompts described in block 606 of FIG. 6 and/or any of the prompts described in the input(s) 301 of FIG. 3.

Per block 909, some embodiments cause presentation, at a device (e.g., a sound device or display device) associated with the operator of the ego-machine, of a representation of the natural language character(s). For example, such representation at block 909 may be included in any representation as described with respect to block 608 of FIG. 6 and/or block 808 of FIG. 8.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), one or more occupant monitoring system (OMS) sensor(s) 1001 (e.g., one or more interior cameras), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

Cameras with a field of view that include portions of the interior environment within the cabin of the vehicle 1000 (e.g., one or more OMS sensor(s) 1001) may be used as part of an occupant monitoring system (OMS) such as, but not limited to, a driver monitoring system (DMS). For example, OMS sensors (e.g., the OMS sensor(s) 1001) may be used (e.g., by the controller(s) 1036) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to execute classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to execute one or more operations of any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may execute a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1016 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be executed simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may execute simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may execute a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to execute a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be provided into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(D) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may execute or operate its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more processing units to:
receive image data representing one or more portions of an operator of an ego-machine, the image data generated using one or more sensors of an ego-machine traversing an environment;
based at least on the image data, generate a representation of a computed alertness level of the operator;
provide the representation of the computed alertness level as an input into one or more machine learning models to generate one or more natural language characters based at least on the computed alertness level of the operator; and
cause presentation, using a display device or sound device associated with the operator of the ego-machine, of a representation of the one or more natural language characters.

2. The one or more processors of claim 1, wherein the one or more processing units are further to:
provide a representation of a phrase utterance that represents an operator response by the operator to the presented representation of the one or more natural language characters as a subsequent input into the one or more machine learning models to generate one or more second natural language characters representing a generated response to the operator response.

3. The one or more processors of claim 1, wherein the one or more processing units are further to:
Provide a representation of personalized information associated with the operator retrieved from a database as at least a portion of the input into the one or more machine learning models, wherein the presentation, using the display device or sound device associated with the operator of the ego-machine, of the representation of the one or more natural language characters generated by the one or more machine learning models comprises a first phrase utterance that initiates a conversation with the operator based at least on the personalized information associated with the operator.

4. The one or more processors of claim 1, wherein the input includes a prompt and the one or more machine learning models includes a Large Language Model (LLM), and wherein the prompt further includes at least one of: personalized information of the operator, the representation of the computed alertness level of the operator, a natural language instruction to start a conversation with the operator that aligns with the operator's interests, a zero-shot, one-shot or few shot examples of representative inputs or outputs, or an instruction to send a control signal to cause a particular action of the ego-machine.

5. The one or more processors of claim 1, wherein the one or more processing units further to:
receive a geo-location indicator that represents a location of the ego-machine in the environment;
based at least on the geo-location indicator, determine at least one of: weather data, road condition data, traffic data, or event data associated with the geo-location; and
provide the at least one of: the weather data, the road condition data, the traffic data, the event data, or the geo-location indicator as at least a portion of the input into the one or more machine learning models, wherein the presentation, using the display device or sound device associated with the operator or occupant of the ego-machine, of the representation of the one or more natural language characters includes a natural language phrase representing a summary of the at least one of: the weather data, the road condition data, the traffic data, or the event data.

6. The one or more processors of claim 1, wherein the one or more processing units further to:
based at least on a geo-location indicator, access first audio data associated with a radio station, wherein the geo-location indicator represents a location of the ego-machine in the environment; and
provide a representation of the audio data as at least a portion of the input into the one or more machine learning models, wherein the one or more natural language characters generated by the one or more machine learning models include a summary of the representation of the audio data.

7. The one or more processors of claim 1, wherein the one or more processing units further to:
access, from one or more data sources, destination or travel route information associated with a destination or travel route of the ego-machine; and
provide a representation of the destination or travel route information as at least a portion of the input into the one or more machine learning models to generate a summarized representation of the destination or travel route information.

8. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processing units to cause presentation, using a device associated with an operator of an ego-machine, of a representation of one or more natural language characters generated using one or more machine learning models based at least on a representation of a computed alertness level of an operator of an ego-machine.

10. The system of claim 9, wherein the one or more processing units are further to:
provide a representation of a phrase utterance that represents an operator response by the operator to the presented representation of the one or more natural language characters as at least a portion of an input into the one or more machine learning models to generate one or more second natural language characters representing a generated response to the operator response.

11. The system of claim 9, wherein the one or more processing units are further to:
provide a representation of personalized information associated with the operator retrieved from a database as at least a portion of an input into the one or more machine learning models, wherein the presentation using at the device associated with the operator of the ego-machine, of the representation of the one or more natural language characters generated by the one or more machine learning models comprises a first phrase utterance that initiates a conversation with the operator based at least on the personalized information associated with the operator.

12. The system of claim 9, wherein the one or more machine learning models includes a Large Language Model (LLM), and wherein a prompt that is provided to the LLM includes at least one of, personalized information of the operator, the representation of the computed alertness level of the operator, a natural language instruction to start a conversation with the operator that aligns with the operator's interests, a zero-shot, one-shot or few shot examples of representative inputs or outputs, or an instruction to send a control signal to cause a particular action of the ego-machine.

13. The system of claim 9, wherein the one or more processing units are further to:
receive a geo-location indicator that represents a location of the ego-machine;
based at least on the geo-location indicator, determine at least one of: weather data, road condition data, traffic data, or event data associated with the geo-location; and
provide the at least one of: the weather data, the road condition data, the traffic data, the event data, or the geo-location indicator as at least a portion of an input into the one or more machine learning models, wherein the presentation, using the device associated with the operator of the ego-machine, of the representation of the one or more natural language characters includes a natural language phrase representing the at least one of: the weather data, the road condition data, the traffic data, or the event data.

14. The system of claim 9, wherein the one or more processing units are further to:
based at least on a geo-location indicator, access first audio data associated with a radio station, wherein the geo-location indicator represents a location of the ego-machine; and
provide a representation of the audio data as at least a portion of the input into the one or more machine learning models, wherein the one or more natural language characters generated by the one or more machine learning models include a summary of the representation of the audio data.

15. The system of claim 9, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

16. A method comprising:
receiving a representation of a computed alertness level of an operator of an ego-machine;
receiving a representation of one or more interests of the operator;
providing the representation of the computed alertness level and the representation of the one or more interests of the operator as at least a portion of an input into one or more machine learning models to generate one or more natural language characters based at least on the computed alertness level of the operator and the one or more interests of the operator; and
causing presentation, using a device associated with the operator of the ego-machine, of a representation of the one or more natural language characters.

17. The method of claim 16, further comprising:
providing a representation of a phrase utterance that represents an operator response by the operator to the presented representation of the one or more natural language characters as a subsequent input into the one or more machine learning models to generate one or more second natural language characters representing a generated response to the operator response.

18. The method of claim 16, wherein the presentation, at the device associated with the operator of the ego-machine, of the representation of the one or more natural language characters generated by the one or more machine learning models comprises presentation, using a sound device, of a first phrase utterance that initiates a conversation with the operator based at least on the one or more interests.

19. The method of claim 16, wherein the input includes a prompt and the one or more machine learning models includes a Large Language Model (LLM), and wherein the prompt further includes at least one of: the one or more interests of the operator, the representation of the computed alertness level of the operator, a natural language instruction to start a conversation with the operator that aligns with the one or more interests, a zero-shot, one-shot or few shot examples of representative inputs or outputs, or an instruction to send a control signal to cause a particular action of the ego-machine.

20. The method of claim 16, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.
